(19) United States
(12) Patent Application Publication
(10) Pub. No.: US 2021/0238436 A1
(43) Pub. Date: Aug. 5, 2021

(54) FLUID SET FOR TEXTILE PRINTING

(71) Applicant: Hewlett-Packard Development Company, L.P., Spring, TX (US)

(72) Inventors: Dennis Z. Guo, San Diego, CA (US); Jie Zheng, San Diego, CA (US)

(21) Appl. No.: 17/048,990

(22) PCT Filed: Aug. 30, 2018
(86) PCT No.: PCT/US2018/048857

§ 371 Date: Oct. 19, 2020

(51) Int. Cl. C09D 11/54; C09D 11/38; C09D 11/322; C09D 11/102; C09D 11/037; C09D 11/033; D06P 5/30; D06P 5/00; D06P 1/52; D06P 1/54; D06P 1/673; B41M 5/00; B41M 7/00

(52) U.S. Cl. CPC C09D 11/54; D06P 3/605; C09D 11/322; C09D 11/102; C09D 11/037; C09D 11/033; D06P 5/30; D06P 5/002; D06P 1/5285; D06P 1/54; D06P 1/67341; B41M 5/0047; B41M 5/0017; B41M 7/0018; C09D 11/38

(57) ABSTRACT

A fluid set includes a pre-treatment composition, an ink composition, and an overcoat composition. The pre-treatment composition includes a multivalent metal salt and an aqueous vehicle. The ink composition includes a pigment, a polyurethane-based binder, and an aqueous ink vehicle. An overcoat composition includes a blocked polyisocyanate crosslinker and an aqueous overcoat vehicle.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings.

FIG. 1 is a flow diagram illustrating an example of a printing method; and

FIG. 2 is a schematic diagram of an example of a printing system.

### DETAILED DESCRIPTION

The textile market is a major industry, and printing on textiles, such as cotton, polyester, etc., has been evolving to include digital printing methods. However, the vast majority of textile printing (≥95%) is still performed by analog methods, such as screen printing. Multi-color printing with analog screen printing involves the use of a separate screen for each color that is to be included in the print, and each color is applied separately (with its corresponding screen). In contrast, digital inkjet printing can generate many colors by mixing basic colors in desired locations on the textile, and thus avoids the limitations of analog screen printing.

Disclosed herein is a fluid set that is suitable for digital inkjet printing on a variety of textile fabrics, including cotton, polyester, polyester and cotton blends, nylon, and silk. The fluid set disclosed herein includes a pre-treatment composition, an ink composition, and an overcoat composition. More specifically, an example of the fluid set includes: a pre-treatment composition including a multivalent metal salt and an aqueous vehicle; an ink composition including a pigment, a polyurethane-based binder, and an aqueous ink vehicle; and an overcoat composition including a blocked polyisocyanate crosslinker and an aqueous overcoat vehicle. Each of these compositions is water-based, and can be formulated for printing via thermal or piezoelectric inkjet printers. It has been found that the compositions, when inkjet printed in sequence on the textile fabric, generate prints having a desirable optical density and washfastness, regardless of the textile fabric used. The multivalent metal salt in the pre-treatment composition interacts with pigment in the ink directly on the textile fabric, which helps fix the pigment and improve the optical density. The blocked polyisocyanate crosslinker in the overcoat composition is deblocked during the curing portion of the printing process, and thus is available for crosslinking. The deblocked polyisocyanate crosslinker can crosslink the functional groups in the polyurethane-based binder in the ink composition, or crosslink the functional groups in the polyurethane-based binder and the functional groups on the fabric substrate.

Moreover, it has been found that maintaining the compositions separately until printing improves the stability of the individual compositions, and improves the effectiveness of the reactions directly on the textile fabric surface. The print attributes may be further enhanced on different textile fabrics by printing different amounts of one or more of the compositions on the different textile fabrics. Maintaining the compositions separately thus enables each of the compositions to be applied independently, which provides flexibility with regard to the amount of each composition that is applied for any given print job. Still further, the reliability of the cartridge, pen, printhead, or other fluid ejection device from which the compositions are dispensed is improved when the compositions are maintained separately. As such, in the examples disclosed herein, the pre-treatment composition, the ink composition, and the overcoat composition are maintained in separate containers or separate compartments in a single container until the compositions are printed.

The various compositions of the fluid set may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of the polyurethane-based binder or the non-ionic or anionic blocked polyisocyanate, a known amount of a sample of the binder or blocked polyisocyanate may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

Throughout this disclosure, a weight percentage that is referred to as “wt % active” refers to the loading of an active component of a dispersion or other formulation that is present in the pre-treatment composition, the ink composition, or the overcoat composition. For example, the blocked polyisocyanate crosslinker may be present in a water-based formulation (e.g., a stock solution or dispersion) before being incorporated into the overcoat composition. In this example, the wt % actives of the blocked polyisocyanate crosslinker accounts for the loading (as a weight percent) of the blocked polyisocyanate that is present in the overcoat composition, and does not account for the weight of the other components (e.g., water, etc.) that are present in the formulation with the blocked polyisocyanate. The term “wt %,” without the term actives, refers to either i) the loading (in the pre-treatment, ink, or overcoat composition) of a 100% active component that does not include other non-active components therein, or the loading (in the pre-treatment, ink, or overcoat composition) of a material or component that is used “as is” and thus the wt % accounts for both active and non-active components.

The various compositions of the fluid set will now be described.

Pre-Treatment Composition

Examples of suitable pre-treatment compositions that may be used in the fluid set with the ink and overcoat compositions include a multivalent metal salt and an aqueous vehicle.

The multivalent metal salt includes a multivalent metal cation and an anion. In an example, the multivalent metal salt includes a multivalent metal cation selected from the group consisting of a calcium cation, a magnesium cation, a zinc cation, an iron cation, an aluminum cation, and combinations thereof; and an anion selected from the group consisting of a chloride anion, an iodide anion, a bromide anion, a nitrate anion, a carboxylate anion, a sulfonate anion, a sulfate anion, and combinations thereof.

It is to be understood that the multivalent metal salt (containing the multivalent metal cation) may be present in any suitable amount. In an example, the metal salt is present in an amount ranging from about 2 wt % to about 15 wt % based on a total weight of the pre-treatment composition. In further examples, the metal salt is present in an amount ranging from about 4 wt % to about 12 wt %; or from about 5 wt % to about 15 wt %; or from about 6 wt % to about 10 wt %, based on a total weight of the pre-treatment composition.

As used herein, the term “aqueous vehicle” may refer to the liquid fluid in which the multivalent metal salt is mixed to form a thermal or a piezoelectric pre-treatment composition.

In an example of the pre-treatment composition, the aqueous vehicle includes water and a co-solvent. Examples of suitable co-solvents for the pre-treatment composition are water soluble or water miscible co-solvents that may be selected from the group consisting of glycerol, ethoxylated glycerol, 2-methyl-1,3-propanediol, trimethylolpropane, 1,2-propanediol, dipropylene glycol, and combinations thereof. Other suitable examples of co-solvents include polyhydric alcohols or simple carbohydrates (e.g., trehalose). Still further examples of the pre-treatment composition co-solvent(s) may include alcohols (e.g., diols), ketones, ketoalcohols, ethers (e.g., the cyclic ether tetrahydrofuran (THF), and others, such as thiodiglycol, sulfolane, 2-pyrrolidone, 1-(2-hydroxyethyl)-2-pyrrolidone,1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol (as mentioned above) and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

Whether used alone or in combination, the total amount of the co-solvent(s) may be present in the pre-treatment composition in an amount ranging from about 5 wt % to about 25 wt % based on a total weight of the pre-treatment composition. The amounts in this range may be particularly suitable for the composition when it is to be dispensed from a thermal inkjet printhead. In another example, the total amount of the co-solvent(s) may be present in the pre-treatment composition in an amount ranging from about 10 wt % to about 18 wt % based on a total weight of the pre-treatment composition. The co-solvent amount may be increased to increase the viscosity of the pre-treatment composition for a high viscosity piezoelectric printhead.

It is to be understood that water is present in addition to the co-solvent(s) and makes up a balance of the pre-treatment composition. As such, the weight percentage of the water present in the pre-treatment composition will depend, in part, upon the weight percentages of the other components. The water may be purified water or deionized water.

An example of the pre-treatment composition further comprises an additive selected from the group consisting of a surfactant, a chelating agent, a buffer, a biocide, and combinations thereof.

Some examples of the pre-treatment composition further include a surfactant. The surfactant may be any surfactant that aids in wetting, but that does not deleteriously interact with the salt in the pre-treatment composition or with the blocked polyisocyanate in the overcoat composition. As such, in an example, the surfactant in the pre-treatment composition is selected from the group consisting of a non-ionic surfactant and a zwitterionic surfactant. The amount of the surfactant that may be present in the pre-treatment composition is 2 wt % active or less (with the lower limit being above 0) based on the total weight of the pre-treatment composition. In some examples, the amount of the surfactant ranges from about 0.05 wt % active to about 1 wt % active based on the total weight of the pre-treatment composition.

Examples of suitable non-ionic surfactants include non-ionic fluorosurfactants, non-ionic acetylenic diol surfactants, non-ionic ethoxylated alcohol surfactants, non-ionic silicone surfactants, and combinations thereof. Several commercially available non-ionic surfactants that can be used in the formulation of the pre-treatment composition include ethoxylated alcohols/secondary alcohol ethoxylates such as those from the TERGITOL® series (e.g., TERGITOL® 15-S-30, TERGITOL® 15-S-9, TERGITOL® 15-S-7), manufactured by Dow Chemical; surfactants from the SURFYNOL® series (e.g., SURFYNOL® SE-F (i.e., a self-emulsifiable wetting agent based on acetylenic diol chemistry), SURFYNOL® 440 and SURFYNOL® 465 (i.e., ethoxylated 2,4,7,9-tetramethyl 5 decyn-4,7-diol)) manufactured by Evonik Industries, and the DYNOL™ series (e.g., DYNOL™ 607 and DYNOL™ 604) manufactured by Air Products and Chemicals, Inc.; fluorinated surfactants, such as those from the ZONYL® family (e.g., ZONYL® FSO and ZONYL® FSN surfactants), manufactured by E.I. DuPont de Nemours and Company; alkoxylated surfactants such as TEGO® Wet 510 manufactured from Evonik; fluorinated POLYFOX® non-ionic surfactants (e.g., PF159 non-ionic surfactants), manufactured by Omnova; silicone surfactants, such as those from BYK® 340 series (e.g., BYK® 345, BYK® 346, BYK® 347, BYK® 348, BYK® 349) manufactured by BYK Chemie; or combinations thereof.

Examples of suitable zwitterionic (amphoteric) surfactants that may be used in the pre-treatment composition include coco-betaine, alkyl isothionates, N,N-dimethyl-N-dodecylamine oxide, N,N-dimethyl-N-tetradecyl amine oxide (i.e., myristamine oxide), N,N-dimethyl-N-hexadecyl amine oxide, N,N-dimethyl-N-octadecyl amine oxide, N,N-dimethyl-N—(Z-9-octadecenyl)-N-amine oxide, N-dodecyl-N,N-dimethyl glycine, lecithins, phospatidylethanolamine, phosphatidylcholine, and phosphatidylserine.

The chelating agent is another example of an additive that may be included in the pre-treatment composition. When included, the chelating agent is present in an amount greater than 0 wt % active and less than or equal to 0.5 wt % active based on the total weight of the pre-treatment composition. In an example, the chelating agent is present in an amount ranging from about 0.05 wt % active to about 0.2 wt % active based on the total weight of the pre-treatment composition.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Buffers are another example of an additive that may be included in the pre-treatment composition. In an example, the total amount of buffer(s) in the pre-treatment composition ranges from 0 wt % to about 0.5 wt % (with respect to the weight of pre-treatment composition). In another example, the total amount of buffer(s) in the ink is about 0.1 wt % (with respect to the weight of pre-treatment composition). Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

Biocides (also referred to herein as antimicrobial agents) are another example of an additive that may be included in the pre-treatment composition. In an example, the total amount of biocide(s) in the pre-treatment composition ranges from about 0 wt % active to about 0.1 wt % active (with respect to the weight of the pre-treatment composition). In another example, the total amount of biocide(s) in the pre-treatment composition ranges from about 0.001 wt % active to about 0.1 wt % active (with respect to the weight of the pre-treatment composition).

Examples of suitable biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

The pH of the pre-treatment composition can be less than 7. In some examples, the pH ranges from pH 1 to pH 7, from pH 3 to pH 7, from pH 4.5 to pH 7, etc.

In an example, the inkjet pre-treatment composition consists of the listed components and no additional components (such as water soluble polymers, water repellent agents, etc.). In other examples, the inkjet pre-treatment composition comprises the listed components, and other components that do not deleteriously affect the jettability of the fluid via a thermal- or piezoelectric inkjet printhead may be added.

Examples of the pre-treatment composition disclosed herein may be used in a thermal inkjet printer or in a piezoelectric printer to pre-treat a textile substrate. The viscosity of the pre-treatment composition may be adjusted for the type of printhead that is to be used, and the viscosity may be adjusted by adjusting the co-solvent level and/or adding a viscosity modifier. When used in a thermal inkjet printer, the viscosity of the pre-treatment composition may be modified to range from about 1 centipoise (cP) to about 9 cP (at 20° C. to 25° C.), and when used in a piezoelectric printer, the viscosity of the pre-treatment composition may be modified to range from about 2 cP to about 20 cP (at 20° C. to 25° C.), depending on the viscosity of the printhead that is being used (e.g., low viscosity printheads, medium viscosity printheads, or high viscosity printheads).

One specific example of the pre-treatment composition includes the multivalent metal salt in an amount ranging from about 5 wt % to about 15 wt % based on the total weight of the pre-treatment composition; an additive selected from the group consisting of a non-ionic surfactant, a chelating agent, an antimicrobial agent, and combinations thereof; and the aqueous vehicle, which includes water and an organic solvent (e.g., the co-solvent).

In some examples, the pre-treatment composition is devoid of a blocked polyisocyanate (e.g., that contained in the overcoat composition).

Ink Composition

Examples of suitable ink compositions that may be used in the fluid set with the pre-treatment and overcoat compositions will now be described. The ink composition may include a pigment, a polyurethane-based binder, and an aqueous ink vehicle.

Pigment

The pigment may be incorporated into the ink composition as a pigment dispersion. The pigment dispersion may include a pigment and a separate dispersant, or may include a self-dispersed pigment. Whether separately dispersed or self-dispersed, the pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Pigments and Separate Dispersants

Examples of the ink composition may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the aqueous ink vehicle. For example, the dispersant can be any dispersing (meth)acrylate polymer, or other type of polymer, such as maleic polymer or a dispersant with aromatic groups and a poly(ethylene oxide) chain.

In one example, (meth)acrylate polymer can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight (M_{w}) ranging from about 4,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

In an example, the pigment is present in the ink composition in an amount ranging from about 1 wt % active to about 6 wt % active of the total weight of the ink composition. In another example, the pigment is present in the ink composition in an amount ranging from about 2 wt % active to about 6 wt % active of the total weight of the inkjet composition. When the separate dispersant is used, the separate dispersant may be present in an amount ranging from about 0.05 wt % active to about 6 wt % active of the total weight of the inkjet composition. In some examples, the ratio of pigment to separate dispersant may range from 0.1 (1:10) to 1 (1:1).

Self-Dispersed Pigments

In other examples, the ink composition includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻M⁺ (monobasic salt), or —PO₃⁻² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X—Sp—(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X—Sp—(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—RCH₂)ₘ(PO₃H₂)]₂, partial esters thereof, or salts thereof, wherein X, m, and n are as described above, and, in an example, X is an arylene group. Still further, the organic group may include at least one group having the formula —X—Sp—(CH₂)ₙ—N—RCH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]_{P}, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed pigment is present in an amount ranging from about 1 wt % active to about 6 wt % active based on a total weight of the ink composition. In an example, the dispersed pigment is present in an amount ranging from about 2 wt % active to about 5 wt % active based on a total weight of the ink composition. In another example, the self-dispersed pigment is present in an amount of about 3 wt % based on the total weight of the ink composition. In still another example, the self-dispersed pigment is present in an amount of about 5 wt % active based on the total weight of the ink composition.

For the pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the pigment dispersion become part of the aqueous ink vehicle in the ink composition.

Polyurethane-Based Binder

The ink composition also includes a polyurethane-based binder. Examples of suitable binders include a polyester-polyurethane binder, a polyether-polyurethane binder, a polycarbonate-polyurethane binder, or hybrids of these binders.

In an example, the ink composition includes the polyester-polyurethane binder. In an example, the polyester-polyurethane binder is a sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (CAS #375390-41-3; Mw 45,000 Mw; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42 (CAS #157352-07-3). Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of polyester-polyurethanes can also be used, including IMPRANIL® DL 1380, IMPRANIL® DLS and IMPRANIL® DLH from Covestro and TAKE LAC® W-5030, TAKELAC® WS-5000 from Mitsui.

The polyester-polyurethane binders disclosed herein may have a weight average molecular weight (Mw) ranging from about 20,000 to about 300,000. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg/g KOH to about 50 mg/g KOH. For this binder, the term “acid number” refers to the mass of potassium hydroxide (KOH) in milligrams that is used to neutralize one gram of the sulfonated polyester-polyurethane binder. To determine this acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

As examples, the acid number of the sulfonated polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

In an example of the ink composition, the polyester-polyurethane binder has a weight average molecular weight ranging from about 20,000 to about 300,000 and an acid number ranging from about 1 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 250 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device.

Other examples of the ink include a polyether-polyurethane binder. Examples of polyether-polyurethanes that may be used include IMPRANIL® LP DSB 1069, IMPRANIL® DLE, IMPRAN IL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the ink include a polycarbonate-polyurethane binder. Examples of polycarbonate-polyurethanes that may be used as the polymeric binder include IMPRAN IL® DLC-F or IMPRANIL® DL 2077 (Covestro (Germany)); or HYDRAN® WLS-213 (DIC Corp. (Japan)); or TAKELAC® W-6110 (Mitsui (Japan)).

In an example, any of the polyurethane-based polymeric binders may be present in the inkjet ink in a total amount ranging from about 2 wt % active to about 24 wt % active of the total weight of the ink composition. In another example, any of the polyurethane-based polymeric binders may be present in the inkjet ink in a total amount ranging from about 2 wt % active to about 15 wt % active of the total weight of the ink composition.

The polymeric binder (prior to being incorporated into the inkjet formulation) may be dispersed in water alone or in combination with an additional water soluble or water miscible co-solvent, such as those described for the pigment dispersion. It is to be understood however, that the liquid components of the binder dispersion become part of the aqueous ink vehicle in the ink formulation.

Aqueous Ink Vehicle

In addition to the pigment and the polyurethane-based binder, the ink composition includes an aqueous ink vehicle.

As used herein, the term “aqueous ink vehicle” may refer to the liquid fluid with which the pigment dispersion and polyurethane-based binder are mixed to form a thermal or a piezoelectric inkjet ink(s). A wide variety of vehicles may be used with the ink composition(s) of the present disclosure. The aqueous ink vehicle may include water and any of: a co-solvent, an anti-kogation agent, an anti-decel agent, a surfactant, a biocide, a pH adjuster, or combinations thereof. In an example, the aqueous ink vehicle consists of water and the co-solvent, the anti-kogation agent, the anti-decel agent, the surfactant, the biocide, a pH adjuster, or a combination thereof. In still another example, the aqueous ink vehicle consists of the anti-kogation agent, the anti-decel agent, the surfactant, the biocide, a pH adjuster, and water.

The aqueous ink vehicle may include co-solvent(s). The co-solvent(s) may be present in an amount ranging from about 4 wt % to about 30 wt % (based on the total weight of the ink composition). In an example, the vehicle includes glycerol. Other examples of co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1, 3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

An anti-kogation agent may also be included in the aqueous ink vehicle of a thermal inkjet composition. Kogation refers to the deposit of dried ink on a heating element of a thermal inkjet printhead. Anti-kogation agent(s) is/are included to assist in preventing the buildup of kogation. In some examples, the anti-kogation agent may improve the jettability of the thermal inkjet ink composition. The anti-kogation agent may be present in the thermal inkjet ink composition in an amount ranging from about 0.1 wt % active to about 1.5 wt % active, based on the total weight of the thermal inkjet ink composition. In an example, the anti-kogation agent is present in an amount of about 0.5 wt % active, based on the total weight of the thermal inkjet ink composition.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The aqueous ink vehicle may include anti-decel agent(s). The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the ink composition. The anti-decel agent(s) may be present in an amount ranging from about 0.2 wt % active to about 5 wt % active (based on the total weight of the ink composition). In an example, the anti-decel agent is present in the ink composition in an amount of about 1 wt % active, based on the total weight of the ink composition.

An example of a suitable anti-decel agent is ethoxylated glycerin having the following formula:

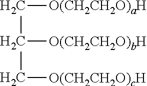

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The aqueous ink vehicle of the ink composition may also include surfactant(s). In any of the examples disclosed herein, the surfactant may be present in an amount ranging from about 0.01 wt % active to about 5 wt % active (based on the total weight of the ink composition). In an example, the surfactant is present in the ink composition in an amount ranging from about 0.05 to about 3 wt %, based on the total weight of the ink composition.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the aqueous ink vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and BYK® 345, BYK® 346, BYK® 347, BYK® 348, BYK® 349 (each of which is a silicone surfactant) (all of which are available from BYK Chemie).

The aqueous ink vehicle may also include biocide(s). In an example, the total amount of biocide(s) in the ink composition ranges from about 0.01 wt % active to about 0.05 wt % active (based on the total weight of the ink composition). In another example, the total amount of biocide(s) in the ink composition is about 0.044 wt % active (based on the total weight of the ink composition). In some instances, the biocide may be present in the pigment dispersion that is mixed with the aqueous ink vehicle. Any of the biocides described for the pre-treatment composition may be used in the ink composition.

The aqueous ink vehicle may also include a pH adjuster. A pH adjuster may be included in the ink composition to achieve a desired pH (e.g., 8.5) and/or to counteract any slight pH drop that may occur over time. In an example, the total amount of pH adjuster(s) in the ink composition ranges from greater than 0 wt % to about 0.1 wt % (based on the total weight of the ink composition). In another example, the total amount of pH adjuster(s) in the ink composition about 0.03 wt % (based on the total weight of the ink composition).

Examples of suitable pH adjusters include metal hydroxide bases, such as potassium hydroxide (KOH), sodium hydroxide (NaOH), etc. In an example, the metal hydroxide base may be added to the ink composition in an aqueous solution. In another example, the metal hydroxide base may be added to the ink composition in an aqueous solution including 5 wt % of the metal hydroxide base (e.g., a 5 wt % potassium hydroxide aqueous solution).

Suitable pH ranges for examples of the ink can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The balance of the ink composition is water. In an example, deionized water may be used. The water included in the ink composition may be: i) part of the pigment dispersion and/or binder dispersion, ii) part of the aqueous ink vehicle, iii) added to a mixture of the pigment dispersion and/or binder dispersion and the aqueous ink vehicle, or iv) a combination thereof. In examples where the ink composition is a thermal inkjet ink, the aqueous ink vehicle includes at least 70% by weight of water. In examples where the ink composition is a piezoelectric inkjet ink, the li aqueous ink quid vehicle is a solvent based vehicle including at least 50% by weight of the co-solvent.

One specific example of the ink composition includes the pigment in an amount ranging from about 1 wt % active to about 6 wt % active based on the total weight of the ink composition; the polyurethane-based binder in an amount ranging from about 2 wt % active to about 24 wt % active of the total weight of the ink composition; a styrene acrylic dispersant; an additive selected from the group consisting of a non-ionic surfactant, an anti-kogation agent, an antimicrobial agent, a anti-decel agent, and combinations thereof; and the aqueous ink vehicle, which includes water and an organic solvent (e.g., the co-solvent disclosed herein).

In some examples, the ink composition is devoid of a multivalent metal salt (e.g., that contained in the pre-treatment composition) and of a blocked polyisocyanate (e.g., that contained in the overcoat composition).

Overcoat Composition

Examples of suitable overcoat compositions that may be used in the fluid set with the pre-treatment and ink compositions will now be described. The overcoat composition may include a blocked polyisocyanate crosslinker, and an aqueous overcoat vehicle.

The isocyanate groups of the blocked polyisocyanate crosslinker can be reactive as crosslinkers when printed on the textile fabric, but within the overcoat composition, the isocyanate groups can remain stable due to a blocking group that is attached to the isocyanate(s). Thus, the term “blocked polyisocyanate” refers to compounds with multiple isocyanate groups where a plurality of the isocyanate groups are coupled to a chemical moiety that stabilize the isocyanate groups in the overcoat composition so that they remain available for reaction after printing on the textile fabric. The chemical moiety that prevents the isocyanate groups from reacting in the overcoat composition can be referred to herein as a “blocking group.” To convert the blocked polyisocyanate to a reactive species, the blocking group can be dissociated from isocyanate groups to result in a “deblocked polyisocyanate.” Deblocking can occur by heating the blocked polyisocyanate to a temperature where dissociation of the blocking group can occur, e.g., typically at from 100° C. to 200° C. There are deblocking or dissociation temperatures outside of this range, e.g., at lower temperatures, but in accordance with examples of the present disclosure, higher temperature deblocking can, in some examples, have the added benefit of accelerating the crosslinking process.

During the deblocking of a blocked polyisocyanate, reaction can occur according to Formulas I or II, as follows:

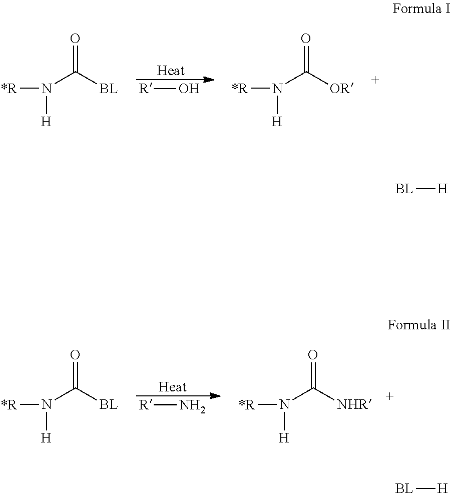

In Formula I and Formula II above, R can be a linking group that connects the blocked isocyanate group shown to any organic group that includes other blocked isocyanates (as the blocked isocyanates used in accordance with the present disclosure is a blocked “poly” isocyanates, meaning that the compound includes more than one isocyanate group). For example, R can independently include a C2 to C10 branched or straight-chained alkyl, C6 to C20 alicyclic, C6 to C20 aromatic, or a combination thereof. The asterisk (*) denotes the organic group with additional blocked isocyanate groups that extend beyond the R linking group (see Formula III below, for example, which includes the balance of a polyisocyanate trimer including two additional isocyanate groups). In further detail, R′ in Formula I and Formula II can be any organic group that can be coupled to the hydroxyl or amine group to replace the blocking group (BL) of the isocyanate, typically liberating a hydrogen to associate with the blocking group, as shown. In one example, R′—OH or R′—NH₂ can be a residual group present in the polyurethane-based binder in the ink composition, and in other examples, the R′—OH group can be present in cotton and cotton blend textile fabrics. In further detail, regarding the dispersed polyurethane-based binder, the binder can be crosslinked when the blocked polyisocyanate is deblocked on the textile fabric.

In an example of the overcoat composition, the blocked polyisocyanate includes blocking groups selected from the group consisting of phenols, ϵ-caprolactam, butanone oxime, diethyl malonate, secondary amines, 1,2,4-triazoles, pyrazoles, and combinations thereof. Butanone oxime is also known as methyl ethyl ketoxime. An example of a suitable pyrazole is 3,5-dimethyl pyrazole.

In an example, the blocked polyisocyanate crosslinker is a cationic blocked polyisocyanate. This blocked polyisocyanate does not have an acid number. One example of a cationic blocked polyisocyanate that can be used is VESTANAT® EP-DS 1076 (an acetoneoxime blocked polyisocyanate based on isophorone diisocyanate commercially available from Evonik Industries (Germany)).

In another example, the blocked polyisocyanate crosslinker is an anionic blocked polyisocyanate or a non-ionic blocked polyisocyanate. In one example, the anionic or non-ionic blocked polyisocyanate crosslinker can include a blocked polyisocyanate trimer. The blocked polyisocyanate trimer can have the structure shown in Formula III, as follows:

(NCO)₃R₃(NHCO)₃(BL)_{3-X}(DL)_{X} Formula III

where R can independently include a C2 to C10 branched or straight-chained alkyl, C6 to C20 alicyclic, C6 to C20 aromatic, or a combination thereof; BL can include a blocking group such as a phenol blocking group, a lactam blocking group, an oxime blocking group, a pyrazole blocking group, or a combination thereof; x can be from 0 to 1; and DL can include an anionic or non-ionic hydrophilic dispersing group.

More specific examples of the R groups include those present to complete isophorone diisocyanate (IPDI) trimers, e.g., methylated alicyclic R groups (sometimes also referred to as cycloaliphatic groups) such as present in N,N′,N″-Tris(5-isocyanato-1,3,3-trimethylcyclohexylmethyl)-2,4,6-triketohexahydrotriazine; or hexanemethylene-1,6-diisocyanate (HDI) trimers, e.g., where R may be C2 to C10 alkyl, C2 to C8 alkyl, C2 to C6 alkyl, C3 to C8 alkyl, C4 to C8 alkyl, or C4 to C10 alkyl.

The hydrophilic dispersing group DL can be an anionic or a non-ionic hydrophilic group that can assist with dispersing the blocked polyisocyanate in the overcoat composition. If DL is present, it can be present at from greater than 0 to 1, or from 0.1 to 1, or from 0.25 to 1, or from 0.5 to 1, or from 0.1 to 0.5, for example. The concentration of DL present can depend on the concentration useful for suspending the blocked polyisocyanate in the overcoat composition.

In one example of Formula III, the blocking group, once liberated (as BL-H) can be ε-caprolactam, butanone oxime, or 3,5-dimethyl pyrazole, for example.

In another, more specific, example of Formula III, x can be from greater than 0 to 1, BL can be a dimethylpyrazole, DL can be N-(2-aminoethyl)-beta-alanine or a salt thereof, and R can be C4 to C8 alkyl or C8 to C14 methylated alicyclic group. In this example, because N-(2-aminoethyl)-beta-alanine is present, x is greater than 0, e.g., from 0.1 to 1.

An example of a suitable blocked polyisocyanate trimer has the structure shown in Formula IV, as follows:

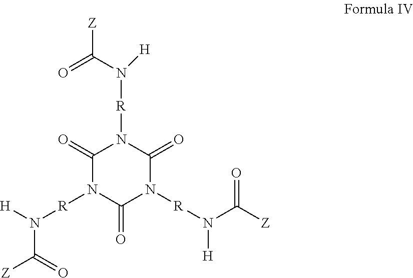

where R is independently a C2 to C10 branched or straight-chained alkyl, C6 to C20 alicyclic, C6 to C20 aromatic, or a combination thereof; and Z independently includes a blocking group (the “BL” groups described herein), a hydrophilic dispersing group (the “DL” groups described herein), or a combination of both. In some examples, the three independent Z groups shown in Formula IV can represent from 2 to 3 blocking groups (BL) and from 0 to 1 hydrophilic dispersing groups (DL) per trimer molecule. Thus, with specific reference to Z in Formula IV, there may be some specific individual molecules in the overcoat composition with three BL groups, and other individual molecules within the in the overcoat composition that include less than three BL groups. Thus, in some examples, there may be no hydrophilic dispersing groups, and in other examples there may be from 0.1 to 1 hydrophilic dispersing groups.

Some specific examples of commercially available anionic blocked polyisocyanates that can be used include IMPRAFIX® 2794 from Covestro (an HDI trimer blocked by 3,5-dimethyl pyrazole and further includes N-(2-aminoethyl)-beta-alaninate; acid number of 10 mg KOH/g) and BAYHYDUR® BL XP 2706 from Covestro (blocked aliphatic polyisocyanate, acid number of 32 mg KOH/g). IMPRAFIX® 2794 can be deblocked at about 130° C.

Some specific examples of commercially available non-ionic blocked polyisocyanates that can be used include Matsui FIXER™ WF-N from Matsui Shikiso Chemical (a 3,5-dimethyl pyrazole non-ionic blocked polyisocyanate) and TRIXENE® Aqua BI 220 from Baxenden (non-ionic aliphatic water-dispersed blocked isocyanate). Matsui FIXER™ WF-N can be deblocked at about 150° C.

Other example blocked polyisocyanates that can be used include, for example BAYHYDUR® BL 2867 from Covestro or VESTANAT® EP-DS 1205 E from Evonik.

In an example of the overcoat composition, the blocked polyisocyanate is present in an amount ranging from about 0.5 wt % active to about 10 wt % active based on a total weight of the overcoat composition. In further examples, the blocked polyisocyanate is present in an amount ranging from about 1 wt % active to about 7 wt % active; or from about 1.5 wt % active to about 5 wt % active; or from about 2 wt % active to about 3 wt % active, based on a total weight of the overcoat composition.

As used herein, the term “aqueous overcoat vehicle” may refer to the liquid fluid in which the blocked polyisocyanate is mixed to form a thermal or a piezoelectric overcoat composition.

In an example of the overcoat composition, the aqueous overcoat vehicle includes water and a co-solvent.

Examples of suitable co-solvents for the overcoat composition are water soluble or water miscible co-solvents, such as those described herein for the pre-treatment composition. In an example, the co-solvent(s) in the aqueous overcoat vehicle are selected from the group consisting of glycerol, 2-pyrrolidone, tetraethylene glycol, 2-methyl-1,3-propanediol, trimethylolpropane, 1,2-propanediol, dipropylene glycol, and combinations thereof.

Whether used alone or in combination, the total amount of the co-solvent(s) may be present in the overcoat composition in an amount ranging from about 5 wt % to about 25 wt % based on a total weight of the overcoat composition. The amounts in this range may be particularly suitable for the composition when it is to be dispensed from a thermal inkjet printhead. In another example, the total amount of the co-solvent(s) may be present in the overcoat composition in an amount ranging from about 10 wt % to about 18 wt % based on a total weight of the pre-treatment composition. The co-solvent amount may be increased to increase the viscosity of the overcoat composition for a high viscosity piezoelectric printhead.

It is to be understood that water is present in addition to the co-solvent(s) and makes up a balance of the overcoat composition. As such, the weight percentage of the water present in the overcoat composition will depend, in part, upon the weight percentages of the other components. The water may be purified water or deionized water.

An example of the overcoat composition further comprises an additive selected from the group consisting of a surfactant, an anti-decel agent, a biocide, and combinations thereof.

Some examples of the overcoat composition further include a surfactant. The surfactant may be any surfactant that aids in wetting, but that does not deleteriously interact with the salt in the pre-treatment composition or with the blocked polyisocyanate in the overcoat composition. As such, any of the non-ionic surfactants or zwitterionic surfactants described herein for the pre-treatment composition may be used in the overcoat composition. The amount of the surfactant that may be present in the overcoat composition is 2 wt % active or less (with the lower limit being above 0) based on the total weight of the overcoat composition. In some examples, the amount of the surfactant ranges from about 0.05 wt % active to about 1 wt % active based on the total weight of the overcoat composition.

The overcoat vehicle may also include anti-decel agent(s). Any of the anti-decel agent(s) described for the ink composition may be used in the overcoat composition. In an example, the anti-decel agent(s) may be present in an amount ranging from about 0.2 wt % to about 15 wt % (based on the total weight of the overcoat composition). In an example, the anti-decel agent is present in the overcoat composition in an amount ranging from about 1.5 wt % to about 5 wt %, based on the total weight of the overcoat composition.

The overcoat vehicle may also include biocide(s). In an example, the total amount of biocide(s) in the overcoat composition ranges from about 0.02 wt % active to about 0.05 wt % active (based on the total weight of the overcoat composition). In another example, the total amount of biocide(s) in the overcoat composition is about 0.044 wt % active (based on the total weight of the ink composition). Any of the biocides described for the pre-treatment composition may be used in the overcoat composition.

The pH of the overcoat composition can range from about 5 to about 11.

In an example, the inkjet overcoat composition consists of the listed components and no additional components. In other examples, the inkjet overcoat composition comprises the listed components, and other components that do not interfere with the function of the blocked polyisocyanate or deleteriously affect the jettability of the fluid via a thermal- or piezoelectric inkjet printhead may be added.

Examples of the overcoat composition disclosed herein may be used in a thermal inkjet printer or in a piezoelectric printer to post-treat an image on a textile substrate. The viscosity of the overcoat composition may be adjusted for the type of printhead that is to be used, and the viscosity may be adjusted by adjusting the co-solvent level and/or adding a viscosity modifier. When used in a thermal inkjet printer, the viscosity of the overcoat composition may be modified to range from about 1 centipoise (cP) to about 9 cP (at 20° C. to 25° C.), and when used in a piezoelectric printer, the viscosity of the overcoat composition may be modified to range from about 2 cP to about 20 cP (at 20° C. to 25° C.), depending on the viscosity of the printhead that is being used (e.g., low viscosity printheads, medium viscosity printheads, or high viscosity printheads).

One specific example of the overcoat composition includes the blocked polyisocyanate in an amount ranging from about 0.5 wt % active to about 10 wt % active based on the total weight of the overcoat composition; and the aqueous overcoat vehicle, which includes water present in an amount ranging from about 70 wt % to about 94.5 wt % based on the total weight of the overcoat composition and an organic solvent (e.g., the co-solvent) present in an amount ranging from about 5 wt % to about 25 wt % based on the total weight of the overcoat composition.

Another specific example of the overcoat composition includes the blocked polyisocyanate in an amount ranging from about 0.5 wt % active to about 10 wt % active based on the total weight of the overcoat composition; an additive selected from the group consisting of a non-ionic surfactant, an anti-decel agent, an antimicrobial agent, and combinations thereof; and the aqueous overcoat vehicle, which includes water and an organic solvent (e.g., the co-solvent).

In some examples, the overcoat composition is devoid of a multivalent metal salt (e.g., that contained in the pre-treatment composition).

Textile Fabrics

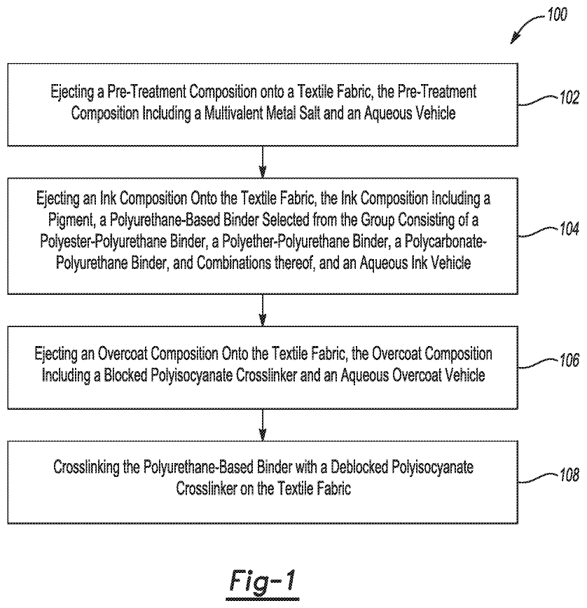

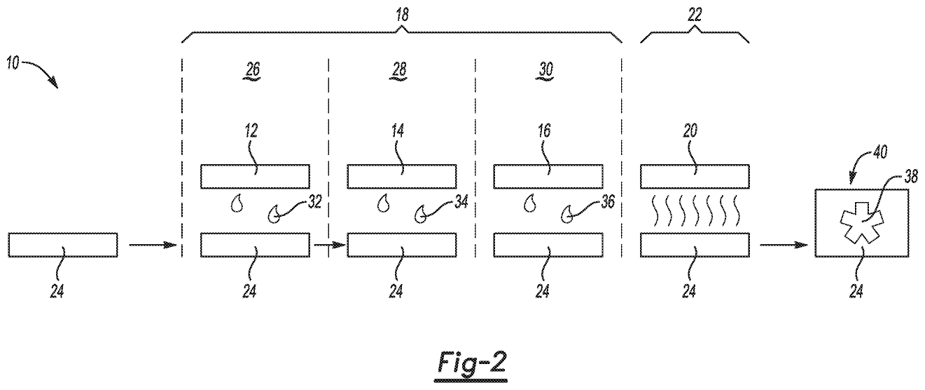

In an example of printing method (shown in FIG. 1) and for use in an example of a printing system (shown in FIG. 2), the textile fabric is selected from the group consisting of polyester fabrics, polyester blend fabrics, cotton fabrics, cotton blend fabrics, nylon fabrics, nylon blend fabrics, silk fabrics, silk blend fabrics, and combinations thereof. In a further example, textile fabric is selected from the group consisting of cotton fabrics and cotton blend fabrics.

It is to be understood that organic textile fabrics and/or inorganic textile fabrics may be used for the textile fabric. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Textile Printing Kit

The textile fabric and the fluid set (e.g., the pre-treatment, ink, and overcoat compositions) described herein may be part of a textile printing kit. In an example, the textile printing kit comprises a textile fabric; a pre-treatment composition including a multivalent metal salt and an aqueous vehicle; an ink composition including a pigment, a polyurethane-based binder, and an aqueous ink vehicle; and an overcoat composition including a blocked polyisocyanate crosslinker and an aqueous overcoat vehicle. It is to be understood that any example of the pre-treatment composition, the ink composition, and the overcoat composition may be used in the examples of the textile printing kit. It is to be understood that any example of the textile fabric may be used in the examples of the textile printing kit. In an example, the textile printing kit comprises a textile fabric selected from the group consisting of polyester fabrics, polyester blend fabrics, cotton fabrics, cotton blend fabrics, nylon fabrics, nylon blend fabrics, silk fabrics, silk blend fabrics, and combinations thereof.

Printing Method and System

FIG. 1 depicts an example of the printing method 100. As shown in FIG. 1, an example the printing method 100 comprises: ejecting a pre-treatment composition onto a textile fabric, the pre-treatment composition including a multivalent metal salt and an aqueous vehicle (as shown at reference numeral 102); ejecting an ink composition onto the textile fabric, the ink composition including a pigment, a polyurethane-based binder selected from the group consisting of a polyester-polyurethane binder, a polyether-polyurethane binder, a polycarbonate-polyurethane binder, and combinations thereof, and an aqueous ink vehicle (as shown at reference numeral 104); ejecting an overcoat composition onto the textile fabric, the overcoat composition, including a blocked polyisocyanate crosslinker and an aqueous overcoat vehicle (as shown at reference numeral 106); and crosslinking the polyurethane-based binder with a deblocked polyisocyanate crosslinker on the textile fabric (as shown at reference numeral 108).

It is to be understood that any example of the pre-treatment composition, the ink composition, and the overcoat composition may be used in the examples of the method 100. It is to be understood that any example of the textile fabric may be used in the examples of the method 100.

As shown in reference numerals 102, 104, and 106 in FIG. 1, the method 100 includes ejecting each of the pre-treatment composition, the ink composition, and the overcoat composition onto at least a portion of the textile fabric.

In an example of the method 100, the pre-treatment composition, the ink composition, and the overcoat composition are applied in a single pass. As an example of single pass printing, the cartridges of an inkjet printer respectively deposit each of the compositions during the same pass of the cartridges across the textile fabric. In other words, the pre-treatment composition, the ink composition, and the overcoat composition are applied sequentially one immediately after the other as the applicators (e.g., cartridges, pens, printheads, etc.) pass over the textile substrate. In other examples, the pre-treatment composition, the ink composition, and the overcoat composition may each be applied in separate passes.

In some examples of the method 100, the ink composition is printed onto the printed pre-treatment composition while the pre-treatment composition is wet, and the overcoat composition is printed onto the printed ink composition while the ink composition is wet. Wet on wet printing may be desirable because less pre-treatment composition may be applied during this process (as compared to when the pre-treatment composition is dried prior to ink application), and because the printing workflow may be simplified without the additional drying. In an example of wet on wet printing, the ink composition is printed onto the printed pre-treatment composition within a period of time ranging from about 0.01 second to about 30 seconds after the printed pre-treatment composition is printed, and the overcoat composition is printed onto the printed ink composition within a period of time ranging from about 0.01 second to about 30 seconds after the printed ink composition is printed. In further examples, a respective composition is printed onto the previously applied composition within a period of time ranging from about 0.1 second to about 20 seconds; or from about 0.2 second to about 10 seconds; or from about 0.2 second to about 5 seconds after the previously applied composition is printed. Wet on wet printing may be accomplished in a single pass.

In another example of the method 100, drying takes place after the application of one composition and before the application of the next composition. As such, the printed pre-treatment composition may be dried on the textile fabric before the ink composition is applied, and the ink composition may be dried before the overcoat composition is applied. It is to be understood that in this example, drying of the respective compositions may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like. When drying is performed, the compositions may be applied in separate passes to allow time for the drying to take place.

As shown in reference numeral 108 in FIG. 1, the method 100 includes crosslinking the polyurethane-based binder with a deblocked polyisocyanate crosslinker on the textile fabric. The deblocked polyisocyanate crosslinker can be generated by applying heat to the blocked polyisocyanate crosslinker on the textile. In an example of the method 100, crosslinking involves heating to a temperature ranging from about 100° C. to about 200° C. for a time suitable to crosslink the deblocked polyisocyanate crosslinker with the polyurethane based binder on the textile fabric (e.g., from about 30 seconds to 5 minutes). In another example, the temperature ranges from about 100° C. to about 180° C. In an example, crosslinking is achieved by heating the print to a temperature of 150° C. for about 3 minutes.

In a further example of the method 100, a ratio of pre-treatment composition printed to ink composition printed ranges from about 0.25:1 by volume to about 2:1 by volume; and a ratio of overcoat composition printed to ink composition printed ranges from 0.25:1 by volume to 2:1 by volume. In an example, a ratio of pre-treatment composition printed to ink composition printed is about 0.25:1 by volume; and a ratio of overcoat composition printed to ink composition printed is 1:3.

Referring now to FIG. 2, a schematic diagram of a printing system 10 including inkjet printheads 12, 14, 16 in a printing zone 18 of the printing system 10 and a dryer 20 positioned in a fixation zone 22 of the printing system 10.

In one example, a textile fabric/substrate 24 may be transported through the printing system 10 along the path shown by the arrows such that the textile fabric 24 is first fed to the printing zone 18. In the printing zone 18, the textile fabric 24 is first transported through a pre-treatment zone 26 where an example of the pre-treatment composition 32 is inkjet printed directly onto the textile fabric 24 by the inkjet printhead 12 (for example, from a piezo- or thermal-inkjet printhead) to form a pre-treatment layer on the textile fabric 24. The pre-treatment layer disposed on the textile fabric 24 may be heated in the printing zone 18 (for example, the air temperature in the printing zone 14 may range from about 10° C. to about 90° C.) such that water may be at least partially evaporated from the pre-treatment layer. The textile fabric 24 is then transported through an ink zone 28 where an example of the ink composition 34 is inkjet printed directly onto the pre-treatment layer on the textile fabric 24 by the inkjet printhead 14 (for example, from a piezo- or thermal-inkjet printhead) to form an ink layer. The ink layer may be heated in the printing zone 18 (for example, the air temperature in the printing zone 14 may range from about 10° C. to about 90° C.) such that water may be at least partially evaporated from the ink layer. The textile fabric 24 is then transported through an overcoat zone 30 where an example of the overcoat composition 36 is inkjet printed directly onto the ink layer on the textile fabric 24 by the inkjet printhead 16 (for example, from a piezo- or thermal-inkjet printhead) to form an overcoat layer.

Rather than specific zones 26, 28, 30 where each of the compositions 32, 34, 36 is applied, it is to be understood that the printing system 10 may include one printing zone 18 where inkjet cartridges are moved across the textile fabric 24 to deposit the compositions 32, 34, 36 in a single pass or in multiple passes.

The textile fabric 24 (having the pre-treatment, ink, and overcoat compositions printed thereon) may then be transported to the fixation (curing) zone 22 where the compositions/layers are heated to fix the pigment and crosslink the crosslinker with the binder. The heat is sufficient to bind the pigment onto the textile fabric 24 and to deblock the crosslinker. The heat to initiate fixation may range from about 100° C. to about 200° C. The fixation of the ink forms the printed article 40 including the image 38 formed on the textile fabric 24.

To further illustrate the present disclosure, examples are given herein. It is to be understood that these examples are provided for illustrative purposes and are not to be construed as limiting the scope of the present disclosure.

### EXAMPLES

### Example 1

Four examples of the ink composition disclosed herein were prepared. The example polyurethane-based binder included in each of the example ink compositions was IMPRANIL® DLN-SD (CAS #375390-41-3; Mw 45,000 Mw; Acid Number 5.2; Tg −47° C.; Melting Point 175-200° C.) from Covestro.

Each example ink composition had the same general formulation except for the type of pigment dispersion. The type of the pigment dispersion in each example ink composition is shown below in Table 2. The general formulation of the example ink compositions, except for the type of pigment dispersion, is shown in Table 1, with the wt % active of each component that was used. For example then, the weight percentage of the pigment dispersion represents the total pigment solids (i.e., wt % active pigment) present in the final ink formulations. In other words, the amount of the pigment dispersion added to the example ink compositions was enough to achieve a pigment solids level equal to the given weight percent. Similarly, the weight percentage of the binder represents the total binder solids (i.e., wt % active binder) present in the final ink formulations. Additionally, a 5 wt % potassium hydroxide aqueous solution was added to each of the example ink compositions until a pH of about 8.5 was achieved.

TABLE 1

| | | Amount |
|---|---|---|
| Ingredient | Specific Component | (wt %) |
| Pigment dispersion | Dispersion K, | 2.5 |
| | Dispersion C, | |
| | Dispersion M, or | |
| | Dispersion Y | |
| Binder | IMPRANIL ® DLN-SD | 6 |
| Co-solvent | Glycerol | 8 |
| Anti-decel agent | LIPONIC ® EG-1 | 1 |
| Anti-kogation agent | CRODAFOS ™ N-3A | 0.5 |
| Surfactant | SURFYNOL ® 440 | 0.3 |
| Biocide | ACTICIDE ® B20 | 0.044 |
| Water | Deionized water | Balance |

The type of the pigment dispersion in each ink composition is shown in Table 2. The pigment color, the pigment color index (C.I.) classification, the dispersant type, the dispersant weight average molecular weight (MW, in Daltons), and the dispersant acid number (AN) (in mg KOH/g) for each example ink composition are also shown in Table 2.

TABLE 2

| Ink | Pigment | Pigment | Pigment C.I. | Dispersant | Dispersant | Dispersant |
|---|---|---|---|---|---|---|
| Composition | Dispersion | Color | Classification | Type | MW | AN |
| Example | Dispersion K | Black | Carbon black | Styrene | 8,000 | 155 |
| black | | | | acrylic | | |
| Example | Dispersion C | Cyan | PB15:3 | Styrene | 8,000 | 185 |
| cyan | | | | acrylic | | |
| Example | Dispersion M | Magenta | PR122/PV19 | Styrene | 10,000 | 172 |
| magenta | | | | acrylic | | |
| Example | Dispersion Y | Yellow | PY74 | Styrene | 11,000 | 185 |
| yellow | | | | acrylic | | |

An example of the pre-treatment composition disclosed herein was also prepared. The example multivalent metal salt included in the example pre-treatment composition was calcium nitrate tetrahydrate (Ca(NO₃)₂.4H₂O). The example pre-treatment composition had a pH of 5.98 and a viscosity of 1.5 cP.

The general formulation of the example pre-treatment composition is shown in Table 3, with the wt % active of each component that was used.

TABLE 3

| | | Amount |
|---|---|---|
| Ingredient | Specific Component | (wt %) |
| Multivalent metal salt | Calcium nitrate | 10 |
| | tetrahydrate | |
| Co-solvent | Tetraethylene glycol | 12 |
| Surfactant | SURFYNOL ® SE-F | 0.07 |
| Chelating agent | TIRON ™ monohydrate | 0.1 |
| Biocide | ACTICIDE ® B20 | 0.04 |
| Water | Deionized water | Balance |

Nine examples of the overcoat composition disclosed herein were also prepared. The example blocked polyisocyanate crosslinker included in the first through fourth example overcoat compositions (i.e., Ex. OC 1, Ex. OC 2, Ex. OC 3, and Ex. OC 4) was IMPRAFIX® 2794 from Covestro (an HDI trimer blocked by 3,5-dimethyl pyrazole and further including N-(2-aminoethyl)-beta-alaninate; acid number of 10 mg KOH/g). The example blocked polyisocyanate crosslinker included in the fifth through eighth example overcoat compositions (i.e., Ex. OC 5, Ex. OC 6, Ex. OC 7, and Ex. OC 8) was Matsui FIXER™ WF-N from Matsui Shikiso Chemical (a 3,5-dimethyl pyrazole non-ionic blocked polyisocyanate). The example blocked polyisocyanate crosslinker included in the ninth example overcoat composition (i.e., Ex. OC 9) was TRIXENE® Aqua BI 220 from Baxenden (non-ionic aliphatic water-dispersed blocked isocyanate which does not contain n-methylpyrrolidone).

The general formulation of each example overcoat composition is shown in Table 4, with the wt % active of each component that was used.

TABLE 4

| | | Ex. | Ex. | Ex. | Ex. | Ex. | Ex. | Ex. | Ex. | Ex. |
|---|---|---|---|---|---|---|---|---|---|---|
| | Specific | OC 1 | OC 2 | OC 3 | OC 4 | OC 5 | OC 6 | OC 7 | OC 8 | OC 9 |
| Ingredient | Component | (wt %) | (wt %) | (wt %) | (wt %) | (wt %) | (wt %) | (wt %) | (wt %) | (wt %) |
| Blocked | IMPRAFIX ® | 2.4 | 2.4 | 2.4 | 2.4 | — | — | — | — | — |
| poly- | 2794 | | | | | | | | | |
| isocyanate | Matsui | — | — | — | — | 2.4 | 2.4 | 2.4 | 2.4 | — |
| crosslinker | FIXER ™ | | | | | | | | | |
| | WF-N | | | | | | | | | |
| | TRIXENE ® | — | — | — | — | — | — | — | — | 2.4 |
| | Aqua BI 220 | | | | | | | | | |
| Co-solvent | Glycerol | 10 | — | — | — | 10 | — | — | — | — |
| | 2-pyrrolidone | — | 10 | — | — | — | 10 | — | — | 10 |
| | Tetraethylene | — | — | 10 | — | — | — | 10 | — | — |
| | glycol | | | | | | | | | |
| | Dipropylene | — | — | — | 10 | — | — | — | 10 | — |
| | glycol | | | | | | | | | |
| Anti-Decel | LIPONIC ® EG-1 | 2 | 2 | 2 | 2 | 2 | 2 | 2 | 2 | 2 |
| Agent | | | | | | | | | | |
| Surfactant | SURFYNOL ® | 0.3 | 0.3 | 0.3 | 0.3 | 0.3 | 0.3 | 0.3 | 0.3 | 0.3 |
| | 440 | | | | | | | | | |
| Biocide | ACTICIDE ® | 0.044 | 0.044 | 0.044 | 0.044 | 0.044 | 0.044 | 0.044 | 0.044 | 0.044 |
| | B20 | | | | | | | | | |
| Water | Deionized water | Bal. | Bal. | Bal. | Bal. | Bal. | Bal. | Bal. | Bal. | Bal. |

Several example prints were generated by thermal inkjet printing using the example pre-treatment composition (i.e., Ex. PT), the example ink compositions, and the first example overcoat composition (i.e., Ex. OC 1). For each example print, the amount of the example pre-treatment composition printed was 5 grams per square meter (gsm); the amount of the example ink composition printed was 20 gsm; and the amount of the first example overcoat composition printed was 6.7 gsm. The example prints were generated on gray cotton, a 65% polyester/35% cotton blend, silk, and nylon. No additional pre-treatment (other than the pre-treatment composition) was performed on any of the fabrics before generating the example prints. Each example print was cured at 150° C. for 3 minutes.

Several comparative prints were also generated by thermal inkjet printing. Comparative prints were generated using: i) the example ink compositions alone without any pre-treatment composition or any overcoat composition, ii) the example pre-treatment composition (i.e., Ex. PT) and the example ink compositions without any overcoat composition, and iii) the example ink compositions and the first overcoat composition (i.e., Ex. OC 1) without any pre-treatment composition. When used, the amount of the example pre-treatment composition printed was 5 gsm; the amount of the example ink composition printed was 20 gsm; and, when used, the amount of the first example overcoat composition printed was 6.7 gsm. The comparative prints were generated on gray cotton, a 65% polyester/35% cotton blend, silk, and nylon. No additional pre-treatment (other than the pre-treatment composition (when used)) was performed on any of the fabrics before generating the comparative prints. Each comparative print was cured at 150° C. for 3 minutes.

Optical Density

The initial optical density (initial OD) of each print was measured. Then, each print was washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (% Δ OD) was calculated for each print.

OD—Gray Cotton Results

The initial optical density (initial OD), the optical density after 5 washes (OD after 5 washes), and the percent change in optical density (% Δ in OD) of each print generated on gray cotton are shown in Table 5. In Table 5, each print is identified by the pre-treatment composition (if any), the ink composition, and the overcoat composition (if any) used to generate the print.

TABLE 5
(Gray Cotton)

| Pre-treatment | | Overcoat | | | |
|---|---|---|---|---|---|
| composition | Ink composition | composition | | | |
| used to generate | used to generate | used to generate | Initial | OD after | % Δ |
| the print | the print | the print | OD | 5 washes | in OD |
| None | Example black | None | 1.087 | 0.976 | −10.3 |
| None | Example cyan | None | 1.079 | 0.966 | −10.5 |
| None | Example magenta | None | 0.942 | 0.863 | −8.4 |
| None | Example yellow | None | 0.939 | 0.855 | −9.0 |
| Ex. PT | Example black | None | 1.287 | 1.009 | −21.6 |
| Ex. PT | Example cyan | None | 1.276 | 1.033 | −19.1 |
| Ex. PT | Example magenta | None | 1.139 | 0.941 | −17.4 |
| Ex. PT | Example yellow | None | 1.173 | 0.948 | −19.2 |
| None | Example black | Ex. OC 1 | 1.011 | 0.996 | −1.4 |
| None | Example cyan | Ex. OC 1 | 1.002 | 0.997 | −0.4 |
| None | Example magenta | Ex. OC 1 | 0.872 | 0.862 | −1.1 |
| None | Example yellow | Ex. OC 1 | 0.879 | 0.882 | 0.3 |
| Ex. PT | Example black | Ex. OC 1 | 1.269 | 1.191 | −6.1 |
| Ex. PT | Example cyan | Ex. OC 1 | 1.257 | 1.204 | −4.2 |
| Ex. PT | Example magenta | Ex. OC 1 | 1.107 | 1.065 | −3.8 |
| Ex. PT | Example yellow | Ex. OC 1 | 1.160 | 1.112 | −4.2 |

As shown in Table 5, each print generated by using the example pre-treatment composition had an initial OD at least 16% greater than the initial OD of each comparative print generated using the same ink composition without any pre-treatment composition. In other words, the prints generated by the example pre-treatment composition and the example black ink composition had an initial OD at least 16% greater than the initial OD of each print generated by the example black ink composition without any pre-treatment composition; the prints generated by the example pre-treatment composition and the example cyan ink composition had an initial OD at least 16% greater than the initial OD of each print generated by the example cyan ink composition without any pre-treatment composition; the prints generated by the example pre-treatment composition and the example magenta ink composition had an initial OD at least 16% greater than the initial OD of each print generated by the example magenta ink composition without any pre-treatment composition; and the prints generated by the example pre-treatment composition and the example yellow ink composition had an initial OD at least 16% greater than the initial OD of each print generated by the example yellow ink composition without any pre-treatment composition. As also shown in Table 5, the change in optical density was less than 10% for each of the prints generated by using first example overcoat composition. Table 5 further shows each example print generated by using the example pre-treatment composition and the first example overcoat composition had an OD after 5 washes at least 19% greater than the OD after 5 washes of each comparative print generated using the same ink composition without any pre-treatment composition, and at least 13% greater than the OD after 5 washes of each comparative print generated using the same ink composition without any overcoat composition.

These results indicate that the prints generated on gray cotton with the example pre-treatment composition, an example ink composition, and the first example overcoat composition have higher optical density than prints generated on gray cotton with i) the example ink compositions alone without any pre-treatment composition or any overcoat composition, ii) the example pre-treatment composition and the example ink compositions without any overcoat composition, and iii) the example ink compositions and the first overcoat composition without any pre-treatment composition.

OD—65% Polyester/35% Cotton Blend Results

The initial optical density (initial OD), the optical density after 5 washes (OD after 5 washes), and the percent change in optical density (% Δ in OD) of each print generated on the 65% polyester/35% cotton blend are shown in Table 6. In Table 6, each print is identified by the pre-treatment composition (if any), the ink composition, and the overcoat composition (if any) used to generate the print.

TABLE 6
(65% Polyester/35% Cotton Blend)

| Pre-treatment | | Overcoat | | | |
|---|---|---|---|---|---|
| composition | Ink composition | composition | | | |
| used to generate | used to generate | used to generate | Initial | OD after | % Δ |
| the print | the print | the print | OD | 5 washes | in OD |
| None | Example black | None | 1.130 | 0.965 | −14.6 |
| None | Example cyan | None | 1.115 | 0.976 | −12.4 |
| None | Example magenta | None | 1.011 | 0.890 | −11.9 |
| None | Example yellow | None | 1.012 | 0.901 | −11.0 |
| Ex. PT | Example black | None | 1.279 | 0.998 | −22.0 |
| Ex. PT | Example cyan | None | 1.259 | 1.021 | −18.9 |
| Ex. PT | Example magenta | None | 1.123 | 0.925 | −17.6 |
| Ex. PT | Example yellow | None | 1.176 | 0.960 | −18.4 |
| None | Example black | Ex. OC 1 | 1.025 | 0.997 | −2.7 |
| None | Example cyan | Ex. OC 1 | 1.028 | 0.993 | −3.4 |
| None | Example magenta | Ex. OC 1 | 0.902 | 0.853 | −5.5 |
| None | Example yellow | Ex. OC 1 | 0.910 | 0.885 | −2.7 |
| Ex. PT | Example black | Ex. OC 1 | 1.263 | 1.136 | −10.0 |
| Ex. PT | Example cyan | Ex. OC 1 | 1.245 | 1.153 | −7.4 |
| Ex. PT | Example magenta | Ex. OC 1 | 1.11 | 1.040 | −6.3 |
| Ex. PT | Example yellow | Ex. OC 1 | 1.159 | 1.106 | −4.6 |

As shown in Table 6, each print generated by using the example pre-treatment composition had an initial OD at least 9% greater than the initial OD of each comparative print generated using the same ink composition without any pre-treatment composition. As also shown in Table 6, the change in optical density was 10% or less for each of the prints generated by using first example overcoat composition. Table 6 further shows each example print generated by using the example pre-treatment composition and the first example overcoat composition had an OD after 5 washes at least 13% greater than the OD after 5 washes of each comparative print generated using the same ink composition without any pre-treatment composition, and at least 12% greater than the OD after 5 washes of each comparative print generated using the same ink composition without any overcoat composition.

These results indicate that the prints generated on the 65% polyester/35% cotton blend with the example pre-treatment composition, an example ink composition, and the first example overcoat composition have higher optical density than prints generated on the 65% polyester/35% cotton blend with i) the example ink compositions alone without any pre-treatment composition or any overcoat composition, ii) the example pre-treatment composition and the example ink compositions without any overcoat composition, and iii) the example ink compositions and the first overcoat composition without any pre-treatment composition.

OD—Silk Results

The initial optical density (initial OD), the optical density after 5 washes (OD after 5 washes), and the percent change in optical density (% Δ in OD) of each print generated on silk are shown in Table 7. In Table 7, each print is identified by the pre-treatment composition (if any), the ink composition, and the overcoat composition (if any) used to generate the print.

TABLE 7
(Silk)

| Pre-treatment | | Overcoat | | | |
|---|---|---|---|---|---|
| composition | Ink composition | composition | | | |
| used to generate | used to generate | used to generate | Initial | OD after | % Δ |
| the print | the print | the print | OD | 5 washes | in OD |
| None | Example black | None | 1.224 | 0.988 | −19.3 |
| None | Example cyan | None | 1.156 | 0.937 | −19.0 |
| None | Example magenta | None | 1.150 | 0.919 | −20.1 |
| None | Example yellow | None | 1.19 | 0.957 | −19.6 |
| Ex. PT | Example black | None | 1.330 | 0.875 | −34.2 |
| Ex. PT | Example cyan | None | 1.336 | 0.977 | −26.9 |
| Ex. PT | Example magenta | None | 1.174 | 0.906 | −22.8 |
| Ex. PT | Example yellow | None | 1.255 | 0.945 | −24.7 |
| None | Example black | Ex. OC 1 | 1.204 | 1.090 | −9.5 |
| None | Example cyan | Ex. OC 1 | 1.156 | 1.043 | −9.8 |
| None | Example magenta | Ex. OC 1 | 1.078 | 0.979 | −9.2 |
| None | Example yellow | Ex. OC 1 | 1.075 | 0.983 | −8.6 |
| Ex. PT | Example black | Ex. OC 1 | 1.341 | 1.214 | −9.5 |
| Ex. PT | Example cyan | Ex. OC 1 | 1.322 | 1.213 | −8.2 |
| Ex. PT | Example magenta | Ex. OC 1 | 1.169 | 1.085 | −7.2 |
| Ex. PT | Example yellow | Ex. OC 1 | 1.26 | 1.150 | −8.7 |

As shown in Table 7, each print generated by using the example pre-treatment composition had an initial OD greater than the initial OD of each comparative print generated using the same ink composition without any pre-treatment composition. As also shown in Table 7, the change in optical density was less than 10% for each of the prints generated by using first example overcoat composition. Table 7 further shows each example print generated by using the example pre-treatment composition and the first example overcoat composition had an OD after 5 washes at least 10% greater than the OD after 5 washes of each comparative print generated using the same ink composition without any pre-treatment composition, and at least 18% greater than the OD after 5 washes of each comparative print generated using the same ink composition without any overcoat composition.

These results indicate that the prints generated on silk with the example pre-treatment composition, an example ink composition, and the first example overcoat composition have higher optical density than prints generated on silk with i) the example ink compositions alone without any pre-treatment composition or any overcoat composition, ii) the example pre-treatment composition and the example ink compositions without any overcoat composition, and iii) the example ink compositions and the first overcoat composition without any pre-treatment composition.

OD—Nylon Results

The initial optical density (initial OD), the optical density after 5 washes (OD after 5 washes), and the percent change in optical density (% Δ in OD) of each print generated on nylon are shown in Table 8. In Table 8, each print is identified by the pre-treatment composition (if any), the ink composition, and the overcoat composition (if any) used to generate the print.

TABLE 8
(Nylon)

| Pre-treatment | | Overcoat | | | |
|---|---|---|---|---|---|
| composition | Ink composition | composition | | | |
| used to generate | used to generate | used to generate | Initial | OD after | % Δ |
| the print | the print | the print | OD | 5 washes | in OD |
| None | Example black | None | 1.181 | 1.069 | −9.4 |
| None | Example cyan | None | 1.141 | 1.058 | −7.2 |
| None | Example magenta | None | 1.089 | 1.013 | −6.9 |
| None | Example yellow | None | 1.131 | 1.053 | −6.9 |
| Ex. PT | Example black | None | 1.401 | 1.293 | −7.7 |
| Ex. PT | Example cyan | None | 1.422 | 1.294 | −9.0 |
| Ex. PT | Example magenta | None | 1.257 | 1.161 | −7.7 |
| Ex. PT | Example yellow | None | 1.359 | 1.256 | −7.6 |
| None | Example black | Ex. OC 1 | 1.094 | 0.959 | −12.3 |
| None | Example cyan | Ex. OC 1 | 1.092 | 1.012 | −7.3 |
| None | Example magenta | Ex. OC 1 | 0.981 | 0.910 | −7.2 |
| None | Example yellow | Ex. OC 1 | 1.047 | 0.989 | −5.5 |
| Ex. PT | Example black | Ex. OC 1 | 1.388 | 1.285 | −7.4 |
| Ex. PT | Example cyan | Ex. OC 1 | 1.424 | 1.281 | −10.0 |
| Ex. PT | Example magenta | Ex. OC 1 | 1.249 | 1.168 | −6.4 |
| Ex. PT | Example yellow | Ex. OC 1 | 1.330 | 1.259 | −5.4 |

As shown in Table 8, each print generated by using the example pre-treatment composition had an initial OD at least 14% greater than the initial OD of each comparative print generated using the same ink composition without any pre-treatment composition. As also shown in Table 8, each example print generated by using the example pre-treatment composition and the first example overcoat composition had an OD after 5 washes at least 15% greater than the OD after 5 washes of each comparative print generated using the same ink composition without any pre-treatment composition, and comparable to the OD after 5 washes of each comparative print generated using the same ink composition without any overcoat composition.

These results indicate that the prints generated on nylon with the example pre-treatment composition, an example ink composition, and the first example overcoat composition have higher optical density than prints generated on nylon with i) the example ink compositions alone without any pre-treatment composition or any overcoat composition, and ii) the example ink compositions and the first overcoat composition without any pre-treatment composition. These results further indicate that prints generated on nylon with the example pre-treatment composition, an example ink composition, and the first example overcoat composition have optical density comparable to prints generated on nylon with the example pre-treatment composition and the example ink compositions without any overcoat composition.

Washfastness

Each print was also tested for washfastness. The L*a*b* values of a color (e.g., cyan, magenta, yellow, black, red, green, blue, white) before and after the 5 washes were measured. L* is lightness, a* is the color channel for color opponents green-red, and b* is the color channel for color opponents blue-yellow. The color change was then calculated using both the CIEDE1976 color-difference formula and the CIEDE2000 color-difference formula.

The CIEDE1976 color-difference formula is based on the CIELAB color space. Given a pair of color values in CIELAB space L*₁,a*₁,b*₁ and L*₂,a*₂,b*₂, the CIEDE1976 color difference between them is as follows:

ΔE₇₆=\sqrt{[(L₂*−L₁*)²+(a₂*−a₁*)²+(b₂*−b₁*)²]}

It is noted that ΔE₇₆ is the commonly accepted notation for CIEDE1976.

The CIEDE2000 color-difference formula is based on the CIELAB color space. Given a pair of color values in CIELAB space L*₁,a*₁,b*₁ and L*₂,a*₂,b*₂, the CIEDE2000 color difference between them is as follows:

ΔE₀₀(L₁*,a₁*,b₁*;L₂*;L₂,*a₂,*b₂*)=ΔE₀₀¹²=ΔE₀₀ (1)

It is noted that ΔE₀₀ is the commonly accepted notation for CIEDE2000.

Given two CIELAB color values {Lᵢ*, aᵢ*, bᵢ*}ᵢ₌₁² and parametric weighting factors k_{L},k_{C},k_{H}, the process of computation of the color difference is summarized in the following equations, grouped as three main parts.

1. Calculate C′ᵢ,h′ᵢ:

$$\begin{matrix}{C}_{i , ab}^{*} = \sqrt{( {( {a}_{i}^{*} )}^{2} + {( {b}_{i}^{*} )}^{2} )} , i = 1 , 2 & ( 2 ) \\ {\overline{C}}_{ab}^{*} = \frac{{C}_{1 , ab}^{*} + {C}_{2 , ab}^{*}}{2} & ( 3 ) \\ G = 0.5 ( 1 - \sqrt{( \frac{{C}_{ab}^{* 7}}{{\overline{C}}_{ab}^{* 7} + {25}^{7}} )} ) & ( 4 ) \\ {a}_{i}^{′} = ( 1 + G ) {a}_{i}^{*} , i = 1 , 2 & ( 5 ) \\ {C}_{i}^{′} \sqrt{( {( {a}_{i}^{′} )}^{2} + {( {b}_{i}^{′} )}^{2} )} , i = 1 , 2 & ( 6 ) \\ {h}_{i}^{′} = \{ \begin{matrix}0 & {b}_{i}^{*} = {a}_{i}^{′} = 0 \\ {tan}^{- 1} ( {b}_{i}^{*} , {a}_{i}^{′} ) & otherwise\end{matrix} , i = 1 , 2 & ( 7 )\end{matrix}$$

2. Calculate ΔL′, ΔC′, ΔH′:

$$\begin{matrix}Δ {L}^{′} = {L}_{2}^{*} - {L}_{1}^{*} & ( 8 ) \\ Δ {C}^{′} = {C}_{2}^{*} - {C}_{1}^{*} & ( 9 ) \\ Δ {h}^{′} = \{ \begin{matrix}0 & {C}_{1}^{′} {C}_{2}^{′} = 0 \\ {h}_{2}^{′} - {h}_{1}^{′} & {C}_{1}^{′} {C}_{2}^{′} \neq 0 ; \vert {h}_{2}^{′} - {h}_{1}^{′} \vert \leq {180}^{°} \\ ( {h}_{2}^{′} - {h}_{1}^{′} ) - 360 & {C}_{1}^{′} {C}_{2}^{′} \neq 0 ; ( {h}_{2}^{′} - {h}_{1}^{′} ) > {180}^{°} \\ ( {h}_{2}^{′} - {h}_{1}^{′} ) + 360 & {C}_{1}^{′} {C}_{2}^{′} \neq 0 ; ( {h}_{2}^{′} - {h}_{1}^{′} ) < - {180}^{°}\end{matrix} & ( 10 ) \\ Δ {H}^{′} = 2 \sqrt{{C}_{1}^{′} {C}_{2}^{′}} sin ( \frac{Δ {h}^{′}}{2} ) & ( 11 )\end{matrix}$$

3. Calculate CIEDE2000 color-difference ΔE₀₀:

$$\begin{matrix} {\overline{L}}^{′} = ( {L}_{1}^{*} - {L}_{2}^{*} ) / 2 & ( 12 ) \\ {\overline{C}}^{′} = ( {C}_{1}^{*} + {C}_{2}^{*} ) / 2 & ( 13 ) \\ {\overline{h}}^{′} = \{ \begin{matrix}\frac{{h}_{1}^{′} + {h}_{2}^{′}}{2} & \vert {h}_{1}^{′} - {h}_{2}^{′} \vert \leq {180}^{°} ; {C}_{1}^{′} {C}_{2}^{′} \neq 0 \\ \frac{{h}_{1}^{′} - {h}_{2}^{′} - 360}{2} & \vert {h}_{1}^{′} - {h}_{2}^{′} \vert > {180}^{°} ; ( {h}_{1}^{′} + {h}_{2}^{′} ) < {360}^{°} ; {C}_{1}^{′} {C}_{2}^{′} \neq 0 \\ \frac{{h}_{1}^{′} - {h}_{2}^{′} - 360}{2} & \vert {h}_{1}^{′} - {h}_{2}^{′} \vert > {180}^{°} ; ( {h}_{1}^{′} + {h}_{2}^{′} ) \geq {360}^{°} ; {C}_{1}^{′} {C}_{2}^{′} \neq 0 \\ ( {h}_{1}^{′} - {h}_{2}^{′} ) & {C}_{1}^{′} {C}_{2}^{′} = 0\end{matrix} & ( 14 ) \\ T = 1 - 0.17 cos ( {\overline{h}}^{′} - {30}^{°} ) + 0.24 cos ( 2 {\overline{h}}^{′} ) + 0.32 cos ( 3 {\overline{h}}^{′} + {6}^{°} ) - 0.20 cos ( 4 {\overline{h}}^{′} - {63}^{°} ) & ( 15 ) \\ Δ θ = 30 exp \{ - {[ \frac{{\overline{h}}^{′} - {275}^{°}}{25} ]}^{2} \} & ( 16 ) \\ {R}_{c} = 2 \sqrt{( \frac{{\overline{C}}^{′ 7}}{{\overline{C}}^{′7} + {25}^{7}} )} & ( 17 ) \\ {S}_{L} = 1 + \frac{0.015 {( {L}^{′} - 50 )}^{2}}{\sqrt{( 20 + {( {L}^{′} - 50 )}^{2} )}} & ( 18 ) \\ {S}_{C} = 1 + 0.045 {\overline{C}}^{′} & ( 19 ) \\ {S}_{H} = 1 + 0.015 {\overline{C}}^{′} T & ( 20 ) \\ {R}_{T} = - sin ( 2 Δ θ ) {R}_{C} & ( 21 ) \\ Δ {E}_{00}^{12} = Δ {E}_{00} ( {L}_{1}^{*} , {a}_{1}^{*} , {b}_{1}^{*} ; {L}_{2}^{*} ; {L}_{2}^{*} , {a}_{2}^{*} , {b}_{2}^{*} ) = \sqrt{( {( \frac{Δ {L}^{′}}{{k}_{L} {s}_{L}} )}^{2} + {( \frac{Δ {C}^{′}}{{k}_{C} {s}_{C}} )}^{2} + {( \frac{Δ {H}^{′}}{{k}_{H} {s}_{H}} )}^{2} + {R}_{T} ( \frac{Δ {C}^{′}}{{k}_{C} {s}_{C}} ) ( \frac{Δ {H}^{′}}{{k}_{H} {s}_{H}} ) )} & ( 22 )\end{matrix}$$

Washfastness—Gray Cotton Results

The results of the ΔE₇₆ calculations and the ΔE₀₀ calculations for each print generated on gray cotton are shown in Table 9. In Table 9, each print is identified by the pre-treatment composition (if any), the ink composition, and the overcoat composition (if any) used to generate the print.

TABLE 9
(Gray Cotton)

| Pre-treatment | | Overcoat | | |
|---|---|---|---|---|
| composition | Ink composition | composition | | |
| used to generate | used to generate | used to generate | | |
| the print | the print | the print | ΔE₇₆ | ΔE₀₀ |
| None | Example black | None | 5.18 | 4.41 |
| None | Example cyan | None | 4.24 | 2.68 |
| None | Example magenta | None | 4.99 | 2.18 |
| None | Example yellow | None | 5.19 | 1.19 |
| Ex. PT | Example black | None | 9.83 | 7.89 |
| Ex. PT | Example cyan | None | 7.61 | 5.28 |
| Ex. PT | Example magenta | None | 6.94 | 3.44 |
| Ex. PT | Example yellow | None | 10.46 | 2.19 |
| None | Example black | Ex. OC 1 | 1.01 | 0.89 |
| None | Example cyan | Ex. OC 1 | 0.57 | 0.25 |
| None | Example magenta | Ex. OC 1 | 1.35 | 0.62 |
| None | Example yellow | Ex. OC 1 | 0.7 | 0.28 |
| Ex. PT | Example black | Ex. OC 1 | 3.37 | 2.67 |
| Ex. PT | Example cyan | Ex. OC 1 | 1.91 | 1.3 |
| Ex. PT | Example magenta | Ex. OC 1 | 2.35 | 0.96 |
| Ex. PT | Example yellow | Ex. OC 1 | 1.99 | 0.46 |

As shown in Table 9, the ΔE₇₆ value and the ΔE₀₀ value of each print generated by using the first example overcoat composition were less than 4. As also shown in Table 9, each print generated by using the first example overcoat composition had a ΔE₇₆ value less than the ΔE₇₆ value of each comparative print generated using the same ink composition without any overcoat composition. Further, Table 9 shows that each print generated by using the first example overcoat composition had a ΔE₀₀ value less than the ΔE₀₀ value of each comparative print generated using the same ink composition without any overcoat composition. Still further, Table 9 shows that the use of the example pre-treatment composition without the first example overcoat composition greatly reduces washfastness (indicated by an increase in the ΔE₇₆ value and the ΔE₀₀ value) as compared to the use the example ink compositions without example pre-treatment composition or the first example overcoat composition.

These results indicate that the prints generated on gray cotton with an example ink composition and the first example overcoat composition have better washfastness than prints generated on gray cotton with the example ink compositions without any overcoat composition.

Washfastness—65% Polyester/35% Cotton Blend Results

The results of the ΔE₇₆ calculations and the ΔE₀₀ calculations for each print generated on the 65% polyester/35% cotton blend are shown in Table 10. In Table 10, each print is identified by the pre-treatment composition (if any), the ink composition, and the overcoat composition (if any) used to generate the print.

TABLE 10
(65% Polyester/35% Cotton Blend)

| Pre-treatment | | Overcoat | | |
|---|---|---|---|---|
| composition | Ink composition | composition | | |
| used to generate | used to generate | used to generate | | |
| the print | the print | the print | ΔE₇₆ | ΔE₀₀ |
| None | Example black | None | 6.89 | 5.77 |
| None | Example cyan | None | 5.39 | 4.27 |
| None | Example magenta | None | 5.17 | 2.73 |
| None | Example yellow | None | 6.13 | 1.44 |
| Ex. PT | Example black | None | 10.45 | 8.46 |
| Ex. PT | Example cyan | None | 7.09 | 5.42 |
| Ex. PT | Example magenta | None | 8.78 | 4.64 |
| Ex. PT | Example yellow | None | 10.36 | 2.2 |
| None | Example black | Ex. OC 1 | 2.13 | 1.83 |
| None | Example cyan | Ex. OC 1 | 1.18 | 1.07 |
| None | Example magenta | Ex. OC 1 | 2.86 | 1.29 |
| None | Example yellow | Ex. OC 1 | 1.41 | 0.54 |
| Ex. PT | Example black | Ex. OC 1 | 4.98 | 3.95 |
| Ex. PT | Example cyan | Ex. OC 1 | 2.53 | 2.01 |
| Ex. PT | Example magenta | Ex. OC 1 | 3.46 | 1.8 |
| Ex. PT | Example yellow | Ex. OC 1 | 3.08 | 0.74 |

As shown in Table 10, the ΔE₇₆ value and the ΔE₀₀ value of each print generated by using the first example overcoat composition were less than 5. As also shown in Table 10, each print generated by using the first example overcoat composition had a ΔE₇₆ value less than the ΔE₇₆ value of each comparative print generated using the same ink composition without any overcoat composition. Further, Table 10 shows that each print generated by using the first example overcoat composition had a ΔE₀₀ value less than the ΔE₀₀ value of each comparative print generated using the same ink composition without any overcoat composition. Still further, Table 10 shows that the use of the example pre-treatment composition without the first example overcoat composition greatly reduces washfastness (indicated by an increase in the ΔE₇₆ value and the ΔE₀₀ value) as compared to the use the example ink compositions without example pre-treatment composition or the first example overcoat composition.

These results indicate that the prints generated on the 65% polyester/35% cotton blend with an example ink composition and the first example overcoat composition have better washfastness than prints generated on the 65% polyester/35% cotton blend with the example ink compositions without any overcoat composition.

Washfastness—Silk Results

The results of the ΔE₇₆ calculations and the ΔE₀₀ calculations for each print generated on silk are shown in Table 11. In Table 11, each print is identified by the pre-treatment composition (if any), the ink composition, and the overcoat composition (if any) used to generate the print.

TABLE 11
(Silk)

| Pre-treatment | | Overcoat | | |
|---|---|---|---|---|
| composition | Ink composition | composition | | |
| used to generate | used to generate | used to generate | | |
| the print | the print | the print | ΔE₇₆ | ΔE₀₀ |
| None | Example black | None | 9.16 | 7.45 |
| None | Example cyan | None | 7.94 | 5.38 |
| None | Example magenta | None | 10.3 | 5.57 |
| None | Example yellow | None | 11.25 | 2.4 |
| Ex. PT | Example black | None | 18.79 | 15.5 |
| Ex. PT | Example cyan | None | 13.46 | 8.5 |
| Ex. PT | Example magenta | None | 10.85 | 5.46 |
| Ex. PT | Example yellow | None | 15.18 | 3.18 |
| None | Example black | Ex. OC 1 | 4.65 | 3.68 |
| None | Example cyan | Ex. OC 1 | 4.45 | 3.06 |
| None | Example magenta | Ex. OC 1 | 4.02 | 2.47 |
| None | Example yellow | Ex. OC 1 | 4.49 | 1.12 |
| Ex. PT | Example black | Ex. OC 1 | 4.27 | 3.23 |
| Ex. PT | Example cyan | Ex. OC 1 | 4.13 | 2.52 |
| Ex. PT | Example magenta | Ex. OC 1 | 3.25 | 1.88 |
| Ex. PT | Example yellow | Ex. OC 1 | 4.04 | 0.87 |

As shown in Table 11, the ΔE₇₆ value and the ΔE₀₀ value of each print generated by using the first example overcoat composition were less than 5. As also shown in Table 11, each print generated by using the first example overcoat composition had a ΔE₇₆ value less than the ΔE₇₆ value of each comparative print generated using the same ink composition without any overcoat composition. Further, Table 11 shows that each print generated by using the first example overcoat composition had a ΔE₀₀ value less than the ΔE₀₀ value of each comparative print generated using the same ink composition without any overcoat composition. Still further, Table 11 shows that the use of the example pre-treatment composition without the first example overcoat composition greatly reduces washfastness (indicated by an increase in the ΔE₇₆ value and the ΔE₀₀ value) as compared to the use the example ink compositions without example pre-treatment composition or the first example overcoat composition.

These results indicate that the prints generated on silk with an example ink composition and the first example overcoat composition have better washfastness than prints generated on silk with the example ink compositions without any overcoat composition.

Washfastness—Nylon Results

The results of the ΔE₇₆ calculations and the ΔE₀₀ calculations for each print generated on nylon are shown in Table 12. In Table 12, each print is identified by the pre-treatment composition (if any), the ink composition, and the overcoat composition (if any) used to generate the print.

TABLE 12
(Nylon)

| Pre-treatment | | Overcoat | | |
|---|---|---|---|---|
| composition | Ink composition | composition | | |
| used to generate | used to generate | used to generate | | |
| the print | the print | the print | ΔE₇₆ | ΔE₀₀ |
| None | Example black | None | 4.64 | 3.73 |
| None | Example cyan | None | 3.82 | 3.13 |
| None | Example magenta | None | 3.33 | 1.91 |
| None | Example yellow | None | 4.18 | 0.92 |
| Ex. PT | Example black | None | 3.09 | 2.27 |
| Ex. PT | Example cyan | None | 2.66 | 1.86 |
| Ex. PT | Example magenta | None | 3.46 | 1.87 |
| Ex. PT | Example yellow | None | 3.57 | 0.72 |
| None | Example black | Ex. OC 1 | 4.64 | 3.93 |
| None | Example cyan | Ex. OC 1 | 3.16 | 2.43 |
| None | Example magenta | Ex. OC 1 | 2.97 | 1.41 |
| None | Example yellow | Ex. OC 1 | 2.55 | 0.56 |
| Ex. PT | Example black | Ex. OC 1 | 3.83 | 2.83 |
| Ex. PT | Example cyan | Ex. OC 1 | 3.7 | 2.47 |
| Ex. PT | Example magenta | Ex. OC 1 | 3.3 | 1.7 |
| Ex. PT | Example yellow | Ex. OC 1 | 3.16 | 0.65 |

As shown in Table 12, the ΔE₇₆ value and the ΔE₀₀ value of each print generated by using the first example overcoat composition were less than 5. As also shown in Table 12, each print generated by using the first example overcoat composition had a ΔE₇₆ value comparable to the ΔE₇₆ value of each comparative print generated using the same ink composition without any overcoat composition. Further, Table 12 shows that each print generated by using the first example overcoat composition had a ΔE₀₀ value comparable to the ΔE₀₀ value of each comparative print generated using the same ink composition without any overcoat composition.

These results indicate that the prints generated on nylon with an example ink composition and the first example overcoat composition have washfastness comparable to prints generated on nylon with the example ink compositions without any overcoat composition.

### Example 2

Several example prints were generated by thermal inkjet printing using the example pre-treatment composition (i.e., Ex. PT), the example ink compositions, and the example overcoat compositions from Example 1. Several comparative prints were also generated by thermal inkjet printing using the example pre-treatment composition (i.e., Ex. PT) and the example ink compositions without any overcoat composition. The amount of the example pre-treatment composition printed was 5 gsm; the amount of the example ink composition printed was 20 gsm; and, when used, the amount of the first example overcoat composition printed was 6.667 gsm. The prints were generated on gray cotton. No additional pre-treatment (other than the pre-treatment composition) was performed on the gray cotton before generating the prints. Each print was cured at 150° C. for 3 minutes.

Optical Density

The initial optical density (initial OD) of each print was measured. Then, each print was washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (% Δ OD) was calculated for each print.

The initial optical density (initial OD), the optical density after 5 washes (OD after 5 washes), and the percent change in optical density (% Δ in OD) of each print are shown in Table 13. In Table 13, each print is identified by the pre-treatment composition, the ink composition, and the overcoat composition (if any) used to generate the print.

TABLE 13
(Gray Cotton)

| Pre-treatment | | Overcoat | | | |
|---|---|---|---|---|---|
| composition | Ink composition | composition | | | |
| used to generate | used to generate | used to generate | Initial | OD after | % Δ |
| the print | the print | the print | OD | 5 washes | in OD |
| Ex. PT | Example black | None | 1.269 | 1.004 | −20.9 |
| Ex. PT | Example cyan | None | 1.274 | 1.045 | −18 |
| Ex. PT | Example magenta | None | 1.09 | 0.934 | −14.4 |
| Ex. PT | Example yellow | None | 1.152 | 0.958 | −16.8 |
| Ex. PT | Example black | Ex. OC 1 | 1.27 | 1.204 | −5.2 |
| Ex. PT | Example cyan | Ex. OC 1 | 1.277 | 1.231 | −3.6 |
| Ex. PT | Example magenta | Ex. OC 1 | 1.08 | 1.058 | −2 |
| Ex. PT | Example yellow | Ex. OC 1 | 1.161 | 1.117 | −3.7 |
| Ex. PT | Example black | Ex. OC 2 | 1.268 | 1.226 | −3.3 |
| Ex. PT | Example cyan | Ex. OC 2 | 1.269 | 1.244 | −2 |
| Ex. PT | Example magenta | Ex. OC 2 | 1.078 | 1.06 | −1.6 |
| Ex. PT | Example yellow | Ex. OC 2 | 1.164 | 1.135 | −2.5 |
| Ex. PT | Example black | Ex. OC 3 | 1.269 | 1.218 | −4 |
| Ex. PT | Example cyan | Ex. OC 3 | 1.272 | 1.237 | −2.8 |
| Ex. PT | Example magenta | Ex. OC 3 | 1.083 | 1.065 | −1.7 |
| Ex. PT | Example yellow | Ex. OC 3 | 1.154 | 1.137 | −1.5 |
| Ex. PT | Example black | Ex. OC 4 | 1.265 | 1.219 | −3.7 |
| Ex. PT | Example cyan | Ex. OC 4 | 1.272 | 1.237 | −2.8 |
| Ex. PT | Example magenta | Ex. OC 4 | 1.091 | 1.072 | −1.7 |
| Ex. PT | Example yellow | Ex. OC 4 | 1.168 | 1.139 | −2.5 |
| Ex. PT | Example black | Ex. OC 5 | 1.275 | 1.166 | −8.5 |
| Ex. PT | Example cyan | Ex. OC 5 | 1.268 | 1.186 | −6.5 |
| Ex. PT | Example magenta | Ex. OC 5 | 1.079 | 1.036 | −3.9 |
| Ex. PT | Example yellow | Ex. OC 5 | 1.147 | 1.071 | −6.6 |
| Ex. PT | Example black | Ex. OC 6 | 1.264 | 1.191 | −5.8 |
| Ex. PT | Example cyan | Ex. OC 6 | 1.272 | 1.21 | −4.8 |
| Ex. PT | Example magenta | Ex. OC 6 | 1.08 | 1.036 | −4.1 |
| Ex. PT | Example yellow | Ex. OC 6 | 1.148 | 1.078 | −6.1 |
| Ex. PT | Example black | Ex. OC 7 | 1.266 | 1.171 | −7.5 |
| Ex. PT | Example cyan | Ex. OC 7 | 1.267 | 1.194 | −5.7 |
| Ex. PT | Example magenta | Ex. OC 7 | 1.088 | 1.046 | −3.9 |
| Ex. PT | Example yellow | Ex. OC 7 | 1.158 | 1.078 | −6.9 |
| Ex. PT | Example black | Ex. OC 8 | 1.265 | 1.166 | −7.8 |
| Ex. PT | Example cyan | Ex. OC 8 | 1.262 | 1.19 | −5.7 |
| Ex. PT | Example magenta | Ex. OC 8 | 1.091 | 1.046 | −4.1 |
| Ex. PT | Example yellow | Ex. OC 8 | 1.153 | 1.08 | −6.3 |
| Ex. PT | Example black | Ex. OC 9 | 1.27 | 1.148 | −9.6 |
| Ex. PT | Example cyan | Ex. OC 9 | 1.26 | 1.167 | −7.4 |

As shown in Table 13, each of the example prints generated by using an example overcoat composition had an initial OD comparable to the initial OD of each comparative print generated using the same ink composition without any overcoat composition. As also shown in Table 13, the change in optical density was less than 10% for each of the prints generated by using an example overcoat composition. Further, Table 13 shows each of the example prints generated by using an example overcoat composition had an OD after 5 washes at least 10% greater than the OD after 5 washes of each comparative print generated using the same ink composition without any overcoat composition.

These results indicate that the prints generated on gray cotton with the example pre-treatment composition, an example ink composition, and an example overcoat composition have higher optical density than prints generated on gray cotton with the example pre-treatment composition and the example ink compositions without any overcoat composition.

Washfastness

Each print was also tested for washfastness. The L*a*b* values of a color (e.g., cyan, magenta, yellow, black, red, green, blue, white) before and after the 5 washes were measured. The color change was then calculated using both the CIEDE1976 color-difference formula and the CIEDE2000 color-difference formula.

The results of the ΔE₇₆ calculations and the ΔE₀₀ calculations for each print are shown in Table 14. In Table 14, each print is identified by the pre-treatment composition, the ink composition, and the overcoat composition (if any) used to generate the print.

TABLE 14
(Gray Cotton)

| Pre-treatment | | Overcoat | | |
|---|---|---|---|---|
| composition | Ink composition | composition | | |
| used to generate | used to generate | used to generate | | |
| the print | the print | the print | ΔE₇₆ | ΔE₀₀ |
| Ex. PT | Example black | None | 10.7 | 8.68 |
| Ex. PT | Example cyan | None | 7.53 | 5.16 |
| Ex. PT | Example magenta | None | 7.89 | 3.81 |
| Ex. PT | Example yellow | None | 10.43 | 2.21 |
| Ex. PT | Example black | Ex. OC 1 | 2.53 | 2.01 |
| Ex. PT | Example cyan | Ex. OC 1 | 1.22 | 0.75 |
| Ex. PT | Example magenta | Ex. OC 1 | 1.3 | 0.51 |
| Ex. PT | Example yellow | Ex. OC 1 | 2.13 | 0.5 |
| Ex. PT | Example black | Ex. OC 2 | 2.43 | 1.94 |
| Ex. PT | Example cyan | Ex. OC 2 | 1.02 | 0.59 |
| Ex. PT | Example magenta | Ex. OC 2 | 1.2 | 0.52 |
| Ex. PT | Example yellow | Ex. OC 2 | 1.62 | 0.44 |
| Ex. PT | Example black | Ex. OC 3 | 2.41 | 1.91 |
| Ex. PT | Example cyan | Ex. OC 3 | 0.93 | 0.54 |
| Ex. PT | Example magenta | Ex. OC 3 | 1.24 | 0.51 |
| Ex. PT | Example yellow | Ex. OC 3 | 1.21 | 0.32 |
| Ex. PT | Example black | Ex. OC 4 | 2.14 | 1.71 |
| Ex. PT | Example cyan | Ex. OC 4 | 1.06 | 0.62 |
| Ex. PT | Example magenta | Ex. OC 4 | 1.54 | 0.59 |
| Ex. PT | Example yellow | Ex. OC 4 | 0.98 | 0.26 |
| Ex. PT | Example black | Ex. OC 5 | 3.49 | 2.77 |
| Ex. PT | Example cyan | Ex. OC 5 | 2.15 | 1.39 |
| Ex. PT | Example magenta | Ex. OC 5 | 2.14 | 0.88 |
| Ex. PT | Example yellow | Ex. OC 5 | 3.88 | 0.83 |
| Ex. PT | Example black | Ex. OC 6 | 3.13 | 2.49 |
| Ex. PT | Example cyan | Ex. OC 6 | 1.74 | 1.09 |
| Ex. PT | Example magenta | Ex. OC 6 | 2.09 | 0.89 |
| Ex. PT | Example yellow | Ex. OC 6 | 3.71 | 0.8 |
| Ex. PT | Example black | Ex. OC 7 | 2.91 | 2.32 |
| Ex. PT | Example cyan | Ex. OC 7 | 2.08 | 1.33 |
| Ex. PT | Example magenta | Ex. OC 7 | 2.35 | 0.94 |
| Ex. PT | Example yellow | Ex. OC 7 | 3.85 | 0.84 |
| Ex. PT | Example black | Ex. OC 8 | 3.6 | 2.87 |
| Ex. PT | Example cyan | Ex. OC 8 | 2.29 | 1.41 |
| Ex. PT | Example magenta | Ex. OC 8 | 1.68 | 0.62 |
| Ex. PT | Example yellow | Ex. OC 8 | 3.34 | 0.71 |
| Ex. PT | Example black | Ex. OC 9 | 4.99 | 4.01 |
| Ex. PT | Example cyan | Ex. OC 9 | 2.75 | 1.89 |

As shown in Table 14, the ΔE₇₆ value and the ΔE₀₀ value of each print generated by using an example overcoat composition were less than 5. As also shown in Table 14, each print generated by using an example overcoat composition had a ΔE₇₆ value less than the ΔE₇₆ value of each comparative print generated using the same ink composition without any overcoat composition. Further, Table 14 shows that each print generated by using an example overcoat composition had a ΔE₀₀ value less than the ΔE₀₀ value of each comparative print generated using the same ink composition without any overcoat composition.

These results indicate that the prints generated on gray cotton with the example pre-treatment composition, an example ink composition, and either example of the overcoat composition have better washfastness than prints generated on gray cotton with the example pre-treatment composition and the example ink compositions without any overcoat composition.

It is to be understood that the ranges provided herein include the stated range and any value or sub-range within the stated range, as if the value(s) or sub-range(s) within the stated range were explicitly recited. For example, a range from about 100° C. to about 200° C. should be interpreted to include not only the explicitly recited limits of from about 100° C. to about 200° C., but also to include individual values, such as about 115° C., about 120.5° C., 150° C., 177° C., etc., and sub-ranges, such as from about 105° C. to about 175° C., etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fluid set, comprising:
a pre-treatment composition, including:
a multivalent metal salt; and
an aqueous vehicle;
an ink composition, including:
a pigment;
a polyurethane-based binder; and
an aqueous ink vehicle; and
an overcoat composition, including:
a blocked polyisocyanate crosslinker; and
an aqueous overcoat vehicle.

2. The fluid set as defined in claim 1 wherein the polyurethane-based binder is selected from the group consisting of a polyester-polyurethane binder, a polyether-polyurethane binder, a polycarbonate-polyurethane binder, and combinations thereof;

3. The fluid set as defined in claim 1 wherein the blocked polyisocyanate crosslinker in the overcoat composition is an anionic blocked polyisocyanate or a non-ionic blocked polyisocyanate.

4. The fluid set as defined in claim 3 wherein the blocked polyisocyanate crosslinker in the overcoat composition is a blocked polyisocyanate trimer having the structure:
(NCO)₃R₃(NHCO)₃(BL)_{3-X}(DL)_{X}
wherein:
R is independently selected from the group consisting of a C2 to C10 branched or straight-chained alkyl, a C6 to C20 alicyclic compound, a C6 to C20 aromatic compound, and combinations thereof; and
BL is selected from the group consisting of a phenol blocking group, a lactam blocking group, an oxime blocking group, a pyrazole blocking group, and combinations thereof;
x is from 0 to 1; and
DL is an anionic or a non-ionic hydrophilic dispersing group.

5. The fluid set as defined in claim 1 wherein the blocked polyisocyanate crosslinker is a cationic blocked polyisocyanate.

6. The fluid set as defined in claim 1 wherein the multivalent metal salt in the pre-treatment composition includes:
a multivalent metal cation selected from the group consisting of a calcium cation, a magnesium cation, a zinc cation, an iron cation, an aluminum cation, and combinations thereof; and
an anion selected from the group consisting of a chloride anion, an iodide anion, a bromide anion, a nitrate anion, a carboxylate anion, a sulfonate anion, a sulfate anion, and combinations thereof.

7. The fluid set as defined in claim 1 wherein:
the blocked polyisocyanate crosslinker is present in the overcoat composition an amount ranging from about 0.5 wt % active to about 10 wt % active based on a total weight of the overcoat composition; and
the aqueous overcoat vehicle includes:
water present in an amount ranging from about 70 wt % to about 94.5 wt % based on the total weight of the overcoat composition; and
an organic co-solvent present in an amount ranging from about 5 wt % to 25 wt % based on the total weight of the overcoat composition.

8. The fluid set as defined in claim 7 wherein the overcoat composition further comprises an additive selected from the group consisting of a non-ionic surfactant, an anti-decel agent, an antimicrobial agent, and combinations thereof.

9. The fluid set as defined in claim 1 wherein the pre-treatment composition, the ink composition, and the overcoat composition are maintained in separate containers or separate compartments in a single container.

10. The fluid set as defined in claim 1 wherein:
the pre-treatment composition includes:
the multivalent metal salt in an amount ranging from about 5 wt % to about 15 wt % based on a total weight of the pre-treatment composition; and
an additive selected from the group consisting of a non-ionic surfactant, a chelating agent, an antimicrobial agent, and combinations thereof; and
the aqueous vehicle includes water and an organic solvent.

11. The fluid set as defined in claim 1 wherein:
the ink composition includes:
the pigment in an amount ranging from about 1 wt % active to about 6 wt % active based on a total weight of the ink composition;
the polyurethane-based binder in an amount ranging from about 2 wt % active to about 24 wt % active based on the total weight of the ink composition;
a styrene acrylic dispersant; and
an additive selected from the group consisting of a non-ionic surfactant, an anti-kogation agent, an antimicrobial agent, an anti-decel agent, and combinations thereof; and
the aqueous ink vehicle includes water and an organic solvent.

12. A textile printing kit, comprising:
a textile fabric;
a pre-treatment composition, including:
a multivalent metal salt; and
an aqueous vehicle;
an ink composition, including:
a pigment;
a polyurethane-based binder selected from the group consisting of a polyester-polyurethane binder, a polyether-polyurethane binder, a polycarbonate-polyurethane binder, and combinations thereof; and
an aqueous ink vehicle; and
an overcoat composition, including:
a blocked polyisocyanate crosslinker; and
an aqueous overcoat vehicle.

13. The textile printing kit as defined in claim 12 wherein the textile fabric is selected from the group consisting of polyester fabrics, polyester blend fabrics, cotton fabrics, cotton blend fabrics, nylon fabrics, nylon blend fabrics, silk fabrics, silk blend fabrics, and combinations thereof.

14. A textile printing method, comprising:
ejecting a pre-treatment composition onto a textile fabric, the pre-treatment composition including:
a multivalent metal salt; and
an aqueous vehicle;
ejecting an ink composition onto the textile fabric, the ink composition including:
a pigment;
a polyurethane-based binder selected from the group consisting of a polyester-polyurethane binder, a polyether-polyurethane binder, a polycarbonate-polyurethane binder, and combinations thereof; and
an aqueous ink vehicle;
ejecting an overcoat composition onto the textile fabric, the overcoat composition, including:
a blocked polyisocyanate crosslinker; and
an aqueous overcoat vehicle; and
crosslinking the polyurethane-based binder with a deblocked polyisocyanate crosslinker on the textile fabric.

15. The textile printing method as defined in claim 14 wherein:
a ratio of pre-treatment composition printed to ink composition printed ranges from 0.25:1 to 2:1 by volume; and
a ratio of overcoat composition printed to ink composition printed ranges from ranges from 0.25:1 to 2:1 by volume.
